(19) United States
(12) Patent Application Publication
(10) Pub. No.: US 2023/0182097 A1
(43) Pub. Date: Jun. 15, 2023

(54) PARTICLE PRODUCTION APPARATUS AND PARTICLE PRODUCTION METHOD

(71) Applicants: Naoki SHIRAISHI, Kanagawa (JP); Shinji Aoki, Kanagawa (JP)

(72) Inventors: Naoki SHIRAISHI, Kanagawa (JP); Shinji Aoki, Kanagawa (JP)

(73) Assignee: Ricoh Company, Ltd., Tokyo (JP)

(21) Appl. No.: 17/596,941

(22) PCT Filed: Jun. 23, 2020
(86) PCT No.: PCT/JP2020/024596

§ 371 Date: Dec. 22, 2021

(30) Foreign Application Priority Data
Jun. 25, 2019 (JP) 2019-117079

(51) Int. Cl. B01J 2/04; B01J 2/18

(52) U.S. Cl. CPC B01J 2/04; B01J 2/18

(57) ABSTRACT

A particle production apparatus includes a liquid droplet formation unit configured to discharge a liquid from a discharging hole to form a liquid droplet, and a particle formation unit configured to solidify the liquid droplet to form a particle. The particle formation unit includes a conveyance gas flow, and the liquid droplet formation unit is configured to discharge the liquid to satisfy Formula 1 below:

$$P = \frac{Vj}{Pd 0} \sqrt{\frac{ρ Vx}{2 A}} {cos}^{2} ( θ - 65 ) > 1 \qquad Formula 1$$

In the Formula 1, Vj represents a velocity (m/s) of the liquid droplet to be discharged, F represents a discharging drive frequency (kHz), d0 represents a diameter (μm) of the liquid droplet, ρ represents a density (kg/m) of the liquid, Vx represents a velocity (m/s) of the conveyance gas flow, A represents shortest distance (m) from the liquid droplet formation unit to a center of the conveyance gas flow, and θ represents an angle (deg.) at which the liquid droplet is to be discharged.

### CROSS-REFERENCE TO RELATED APPLICATIONS

This application is the National Stage entry under § 371 of International Application No. PCT/JP2020/024596, filed on Jun. 23, 2020, and which claims the benefit of priority to Japanese Application No. 2019-117079, filed on Jun. 25, 2019. The content of each of these applications is hereby incorporated by reference in its entirety.

### TECHNICAL FIELD

The present disclosure relates to a particle production apparatus and a particle production method.

### BACKGROUND ART

Conventionally, particles containing physiologically active substances such as pharmaceutical compounds have been produced in use of pharmaceuticals.

For example, a method for producing a medicine particle by spraying and drying a liquid containing a physiologically active substance by the spray-drying method has been proposed (see, for example, PTL 1).

In order to improve characteristics such as variation in a dissolution rate, a dissolution amount, and a handling ability of a particle, and to obtain a particle having a small size and a narrow particle size distribution, a particle production method of an inkjet discharging system utilizing a liquid column resonance method has been proposed (see, for example, PTL 2).

A method in which a liquid housing section including: a thin film on which a plurality of nozzles are formed; and a piezoelectric element configured to vibrate the thin film is used discharge a liquid from the plurality of nozzles to form a toner particle has been proposed (see, for example, PTL 3).

Moreover, in a method for producing a particle by solidifying liquid droplets using a gas flow, a particle production apparatus has been proposed, where, in the apparatus, nozzles are provided in the form of a hound's tooth check on a surface on which the nozzles are formed, and a direction of the gas flow intersects with a direction in which liquid droplets are discharged at substantially right angle, in order to prevent the particle size distribution of a particle to be obtained from being broadened when liquid droplets discharged from the nozzles cohere (hereinafter, may be referred to as “coalescence”) (see, for example, PTL 4).

### CITATION LIST

### Patent Literature

PTL 1: Japanese Unexamined Patent Application Publication No. 8-281155

PTL 2. Japanese Unexamined Patent Application Publication No. 2017-160188

PTL 3: Japanese Unexamined Patent Application Publication No. 2008-292976

PTL 4: Japanese Patent No. 6103466

### SUMMARY OF INVENTION

### Technical Problem

An object of the present disclosure is to provide a particle production apparatus that can produce a particle having a narrow particle size distribution in large quantities.

### Solution to Problem

According to one aspect of the present disclosure, a particle production apparatus includes: a liquid droplet formation unit configured to discharge a liquid from a discharging hole to form a liquid droplet; and a particle formation unit configured to solidify the liquid droplet to form a particle. The particle formation unit includes a conveyance gas flow. The liquid droplet formation unit is configured to discharge the liquid so as to satisfy Formula 1 below.

$$\begin{matrix}[ Math . 1 ] & \\ P = \frac{Vj}{Pd 0} \sqrt{\frac{ρ Vx}{2 A}} {cos}^{2} ( θ - 65 ) > 1 & Formula 1\end{matrix}$$

In the Formula 1, Vj represents a velocity (m/s) of the liquid droplet to be discharged, F represents a discharging drive frequency (kHz), d0 represents a diameter (μm) of the liquid droplet, ρ represents a density (kg/m³) of the liquid, Vx represents a velocity (m/s) of the conveyance gas flow, A represents shortest distance (m) from the liquid droplet formation unit to a center of the conveyance gas flow, and θ represents an angle (deg.) at which the liquid droplet is to be discharged.

### Advantageous Effects of Invention

According to the present disclosure, it is possible to provide a particle production apparatus that can produce a particle having a narrow particle size distribution in large quantities.

### BRIEF DESCRIPTION OF DRAWINGS

FIG. 1A is a schematic view presenting one example of discharged liquid droplets.

FIG. 1B is a schematic view presenting another example of discharged liquid droplets.

FIG. 1C is a schematic view presenting one example of a relationship between discharged liquid droplets and a conveyance path.

FIG. 1D is a schematic view presenting another example of a relationship between discharged liquid droplets and a conveyance path.

FIG. 1E is a schematic view presenting another example of a relationship between discharged liquid droplets and a conveyance path.

FIG. 2A is a schematic view presenting one example of distribution of conveyance gas flow.

FIG. 2B is a schematic view presenting one example of a relationship between a liquid droplet formation unit and a center of a conveyance gas flow.

FIG. 2C is a schematic view presenting another example of a relationship between a liquid droplet formation unit and a center of a conveyance gas flow.

FIG. 3A is a schematic view presenting one example of an angle at which the liquid droplet is to be discharged.

FIG. 3B is a schematic view presenting another example of an angle at which the liquid droplet is to be discharged.

FIG. 3C is a schematic view presenting one example of discharging holes (nozzles) and an angle at which the liquid droplet is to be discharged.

FIG. 3D is a schematic view presenting another example of discharging holes (nozzles) and an angle at which the liquid droplet is to be discharged.

FIG. 4A is a schematic view presenting one example of a particle production apparatus.

FIG. 4B is a schematic view presenting one example of a particle production apparatus.

FIG. 5 is a schematic view presenting one example of a volume-changing member used in a particle production apparatus.

FIG. 6A is a side view presenting one example of a liquid droplet formation unit using a nozzle-vibrating member used in a particle production apparatus.

FIG. 6B is a side view presenting one example of a liquid droplet formation unit using a nozzle-vibrating member used in a particle production apparatus.

FIG. 7A is a schematic view presenting one example of a liquid droplet formation unit using a constricted part generation member used in a particle production apparatus.

FIG. 7B is a schematic view presenting one example of a constricted part generation member used in a particle production apparatus.

### DESCRIPTION OF EMBODIMENTS

(Particle Production Apparatus and Particle Production Method)

A particle production apparatus of the present disclosure includes: a liquid droplet formation unit configured to discharge a liquid from a discharging hole to form a liquid droplet; and a particle formation unit configured to solidify the liquid droplet to form a particle. The particle formation unit includes a conveyance gas flow, and the liquid droplet formation unit is configured to discharge the liquid so as to satisfy Formula 1 below. The particle production apparatus of the present disclosure includes a liquid housing section, and further includes other members if necessary.

$$\begin{matrix}[ Math . 2 ] & \\ P = \frac{Vj}{Pd 0} \sqrt{\frac{ρ Vx}{2 A}} {cos}^{2} ( θ - 65 ) > 1 & Formula 1\end{matrix}$$

In the Formula 1, Vj represents a velocity (m/s) of the liquid droplet to be discharged, F represents a discharging drive frequency (kHz), d0 represents a diameter (μm) of the liquid droplet, ρ represents a density (kg/m³) of the liquid, Vx represents a velocity (m/s) of the conveyance gas flow, A represents shortest distance (m) from the liquid droplet formation unit to a center of the conveyance gas flow, and θ represents an angle (deg.) at which the liquid droplet is to be discharged.

A particle production method of the present disclosure includes: discharging a liquid from a discharging hole to form a liquid droplet by a liquid droplet formation unit; and solidifying the liquid droplet to form a particle by a particle formation unit. The particle formation unit includes a conveyance gas flow, and the liquid droplet formation unit is configured to discharge the liquid so as to satisfy Formula 1 below. The particle production method of the present disclosure includes other steps if necessary.

$$\begin{matrix}[ Math . 3 ] & \\ P = \frac{Vj}{Fd 0} \sqrt{\frac{ρ Vx}{2 A}} {cos}^{2} ( θ - 65 ) > 1 & Formula 1\end{matrix}$$

where in the Formula 1, Vj represents a velocity (m/s) of the liquid droplet to be discharged, F represents a discharging drive frequency (kHz), d0 represents a diameter (μm) of the liquid droplet, ρ represents a density (kg/m³) of the liquid, Vx represents a velocity (m/s) of the conveyance gas flow, A represents shortest distance (m) from the liquid droplet formation unit to a center of the conveyance gas flow, and θ represents an angle (deg.) at which the liquid droplet is to be discharged.

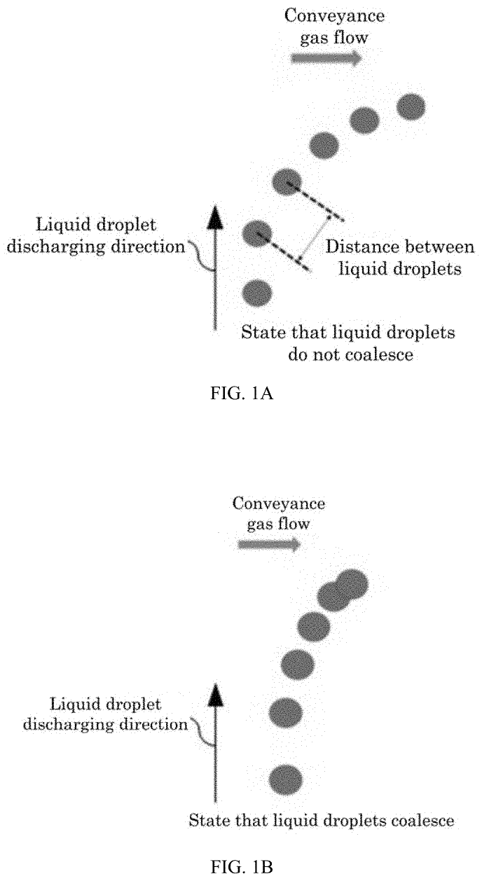

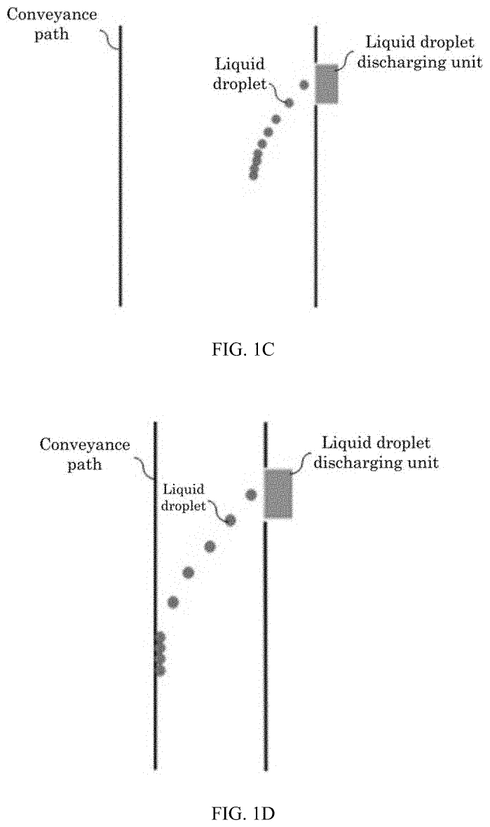

As a result of studies on an apparatus that produces a particle having a narrow particle size distribution in large quantities, the present inventors obtained the following findings. Liquid droplets discharged from discharging holes (nozzles) receive air resistance, which results in reduction of the velocity. When a conveyance gas flow is weak (a flow rate of the conveyance gas flow is small), a liquid droplet previously discharged from a nozzle may be caught up with by a liquid droplet subsequently discharged from the same nozzle, which may result in coalescence of the liquid droplets. Meanwhile, when the conveyance gas flow is strong, a liquid droplet is accelerated by the conveyance gas flow, which makes it possible to prevent liquid droplets from coalescing with each other (see, for example, FIG. 1A).

The liquid droplets discharged from discharging holes (nozzles) at a certain initial velocity Vo receive air resistance to decrease the velocity. Finally, the liquid droplets come to have a velocity having the same vector as the velocity of the conveyance gas flow. For example, as presented in FIG. 1B, when a flow rate of the conveyance gas flow is small, liquid droplets coalesce with each other. Therefore, the flow rate of the conveyance gas flow is desirably large.

In the conventional techniques, in the case where liquid droplets discharged using the conveyance gas flow are solidified, it is necessary to increase a velocity of the liquid droplet to be discharged in order to increase a production amount of the particle. However, when the velocity of the liquid droplet to be discharged is increased, a distance over which the discharged liquid droplets fly (horizontal distance from the discharging hole) is increased, which may enlarge an apparatus to be designed.

In addition, the conventional techniques have problems that when the velocity of the liquid droplet to be discharged is increased in order to improve production efficiency, a diameter of the liquid droplet to be discharged becomes small, which cannot achieve a particle having a desired size in some cases.

In the case where the particle production apparatus of the present disclosure satisfies conditions according to production of the particle, even when the velocity of the liquid droplet to be discharged is increased, a particle having a narrow particle size distribution can be produced in mass production. That is, even when the liquid droplet with a desired diameter is discharged while the discharging velocity is increased, discharged liquid droplets can be controlled so as not to coalesce with each other. As a result, it is possible to produce a particle having a narrow particle size distribution in mass production. The particle production apparatus of the present disclosure is particularly suitable for producing a particle having a volume average particle diameter of 10 μm or more.

According to the particle production apparatus of the present disclosure, even a particle having such a size that is equal to or larger than single micron (i.e., a particle having a volume average particle diameter of 10 μm or more) can be produced in mass production. Therefore, a volume average particle diameter of the particle produced by the production apparatus of the present disclosure is preferably 10 μm or more but 100 μm or less, more preferably 20 μm or more but 40 μm or less.

The volume average particle diameter of the particle can be measured using, for example, a laser diffraction/scattering particle size distribution analyzer (device name: MICROTRAC MT3000II, available from MicrotracBEL Corp.).

<Liquid Droplet Formation Step and Liquid Droplet Formation Unit>

The liquid droplet formation step is a step of discharging a liquid from a discharging hole to form a liquid droplet, and is performed by a liquid droplet formation unit.

The liquid droplet formation unit is configured to discharge the liquid so as to satisfy Formula 1 below.

$$\begin{matrix}[ Math . 4 ] & \\ P = \frac{Vj}{Fd 0} \sqrt{\frac{ρ Vx}{2 A}} {cos}^{2} ( θ - 65 ) > 1 & Formula 1\end{matrix}$$

In the Formula 1, Vj represents a velocity (m/s) of the liquid droplet to be discharged, F represents a discharging drive frequency (kHz), d0 represents a diameter (μm) of the liquid droplet, ρ represents a density (kg/m³) of the liquid, Vx represents a velocity (m/s) of the conveyance gas flow, A represents shortest distance (m) from the liquid droplet formation unit to a center of the conveyance gas flow, and θ represents an angle (deg.) at which the liquid droplet is to be discharged. In the Formula 1, the P represents a numerical value obtained by dividing distance between a center of a liquid droplet (liquid droplet 1) discharged from a discharging hole and a center of a liquid droplet (liquid droplet 2) subsequently discharged from the same discharging hole, each of the liquid droplets being discharged from a certain discharging hole by a diameter of a liquid droplet. When the value of P is less than 1, the liquid droplets theoretically coalesce with each other. Therefore, it is necessary for the value of P to be more than 1 in order to avoid coalescence of particles.

The value of P is preferably 2 or more, more preferably 2.5 or more, still more preferably 3 or more considering, for example, variations. In the case where the value of P is 2 or more, even when the velocity of the liquid droplet to be discharged is increased, a particle having such a size that is equal to or larger than a desirable size can be produced in mass production.

The velocity (Vj) (m/s) of the liquid droplet to be discharged is a velocity immediately after the liquid droplet is discharged from the discharging hole.

For example, the velocity Vj (m/s) of the liquid droplet to be discharged is preferably 5 m/s or more but 50 m/s or less, more preferably 7 m/s or more but 30 m/s or less.

A diameter d0 (μm) of the liquid droplet is a diameter of the liquid droplet immediately after the liquid droplet is discharged from the discharging hole.

The diameter d0 (μm) of the liquid droplet is preferably 5 μm or more but 100 μm or less, more preferably 10 μm or more but 50 μm or less.

The velocity of the liquid droplet to be discharged and the diameter of the liquid droplet can be measured by liquid droplet observation device (device name: EV1000, available from Ricoh Company, Ltd.) with an LED back light.

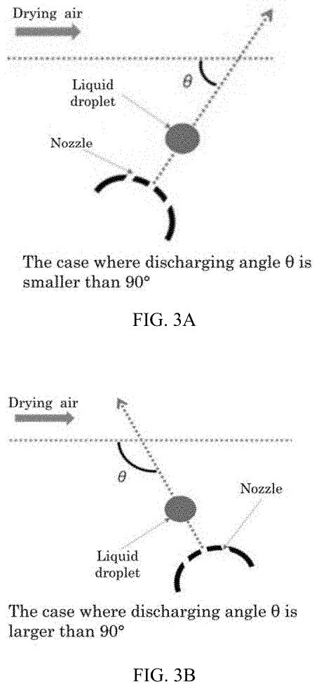

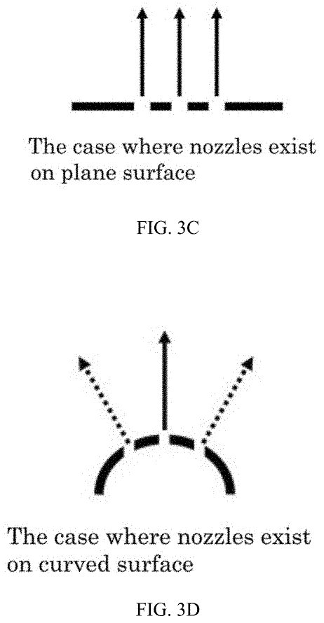

The angle (deg.) at which the liquid droplet is to be discharged (0) is an angle at which a direction of movement of the liquid droplet at the moment when the liquid droplet is discharged from the discharging hole (nozzle) intersects with a direction of stress the liquid droplet receives from the conveyance gas flow (see, for example, FIG. 3A and FIG. 3B). When the liquid droplet formation unit includes a plurality of discharging holes (nozzles), there are the following two cases; (i) the case where discharging holes (nozzles) exist on a plane surface as presented in FIG. 3C; and (ii) the case where discharging holes (nozzles) exist on a curved surface as presented in FIG. 3D. Particularly, in the case of (ii), each direction in which the liquid droplet is discharged from each discharging hole is different. Therefore, an angle, at which a traveling direction of the liquid droplet at the moment when the liquid droplet is discharged from the discharging hole (nozzle) positioned in the center of the liquid droplet formation unit intersects with a direction of stress the liquid droplet receives from the conveyance gas flow, is measured as the angle at which the liquid droplet is to be discharged (see, for example, FIG. 3D).

For example, the angle at which the liquid droplet is to be discharged is preferably 40° or more but 90° or less, more preferably 600 or more but 750 or less.

The angle at which the liquid droplet is to be discharged can be appropriately selected by adjusting directions of the discharging hole and the conveyance gas flow.

The density ρ (kg/m³) of the liquid is mass of the liquid per unit volume.

For example, the density ρ (kg/m³) of the liquid is preferably 500 kg/m³ or more but 1500 kg/m³ or less, more preferably 700 kg/m³ or more but 1200 kg/m³ or less.

The density ρ (kg/m³) of the liquid can be measured based on JIS Z 8804: 2012.

The conveyance gas flow prevents the velocity of the liquid droplet to be discharged immediately after the liquid droplet is discharged from being decreased, and suppresses cohesion (unification) of the liquid droplets. The conveyance gas flow is provided for the following reasons.

When discharged liquid droplets contact with each other before the liquid droplets are dried, the liquid droplets are unified to form one liquid droplet (hereinafter, this phenomenon is referred to as coalescence). In order to obtain a particle having a uniform (narrow) particle size distribution, it is necessary to maintain a certain distance between the discharged droplets. However, the discharged liquid droplet travels at a certain initial velocity, but the velocity of the liquid droplet is decreased soon due to air resistance. The liquid droplet decreased in the velocity is caught up with by a liquid droplet subsequently discharged, which leads to coalescence. This phenomenon occurs regularly, and thus particle size distribution of the resultant particle is not uniform (narrow). In order to prevent coalescence of the liquid droplets, it is necessary to prevent the velocity of the liquid droplet to be discharged from being decreased, and to solidify/convey the liquid droplet while coalescence of the liquid droplets is prevented by means of conveyance gas flow so that the liquid droplets do not contact with each other. A flow rate (m/s) of the conveyance gas flow is defined as a velocity of the conveyance gas flow Vx (m/s).

The conveyance gas flow is a gas flow that dries and solidifies the liquid droplet discharged in the particle production apparatus, and is a gas flow that flows in a conveyance path that can be equipped in, for example, the production apparatus. When the conveyance gas flow flows in the conveyance path, it is assumed that the conveyance gas flow follows the formula of Hagen-Poiseuille, and is in the laminar flow condition without the turbulent variations.

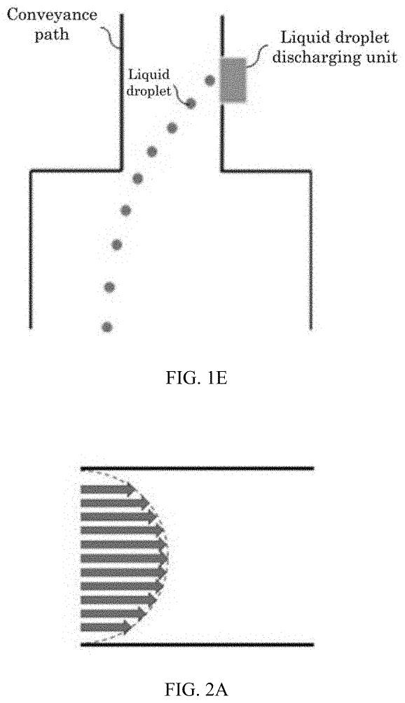

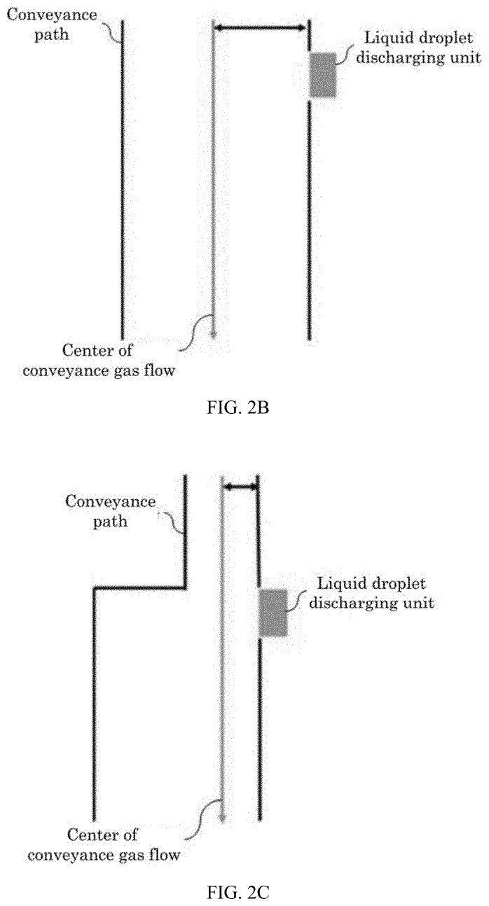

A velocity distribution of the conveyance gas flow is defined by the following Formula 2, and the velocity distribution presents a parabola (see FIG. 2A).

$$\begin{matrix}[ Math . 5 ] & \\ U ( r ) = \frac{{gI}_{e}}{4 v} ( {a}^{2} - {r}^{2} ) & Formula 2\end{matrix}$$

In the Formula 2, U (r) represents a flow rate (m/s) of the conveyance gas flow, r represents the shortest distance (horizontal distance) (m) (where 0<r<a, and a represents a radius of a circular pipe) from the center of the conveyance gas flow to the discharging hole, g represents gravitational acceleration (m/s²), Ie represents hydraulic gradient or energy gradient, and ν represents coefficient of kinematic viscosity (m²/s).

For example, the velocity of the conveyance gas flow Vx (m/s) is preferably 4 m/s or more but 50 m/s or less, more preferably 8 m/s or more but 20 m/s or less.

Here, the velocity of the conveyance gas flow is an average value.

When the conveyance path has a point-symmetry structure (e.g., circular pipe and square pipe), the maximum value of the velocity of the conveyance gas flow is at the center of the pipe. However, this is not applied to the case where pipes with circle equivalent diameters having a different cross-sectional shape intersecting with the long axis of the conveyance path are combined, and the case where the conveyance path is curved so as to form a U-shaped curve. In one aspect, the flow rate of the conveyance gas flow can be adjusted by changing a diameter of the conveyance path. For example, as presented in FIG. 1C, when the diameter of the pipe of the conveyance path is large, a cross-sectional area, which intersects with a direction in which the conveyance gas flow is conveyed in the conveyance path, becomes large, which decreases the velocity of the gas flow at the same flow rate of the conveyance gas flow. In this case, the liquid droplets easily coalesce with each other, a pipe diameter in the conveyance path with which the discharging holes (nozzles) face is preferably small from the aforementioned viewpoint as presented in FIG. 1D. Meanwhile, as the discharging velocity of the liquid droplet is higher, the horizontal distance over which the liquid droplet flies becomes large. In such a case, when the pipe diameter of the conveyance path is small, the liquid droplet discharged from the discharging hole (nozzle) collide with the surface of the pipe facing the discharging hole (nozzle) before the liquid droplet is dried. As a result, a particle cannot be obtained, which is problematic. Therefore, as presented in FIG. 1E, it is necessary to design a pipe diameter or a shape of the conveyance path by, for example, decreasing the pipe diameter of the conveyance path with which the discharging holes (nozzles) face, and increasing the pipe diameter in the conveyance process.

As mentioned below, the present inventors revealed that when a distance from the discharging hole to the center of the conveyance gas flow is shortened, an effect of the conveyance gas flow on the liquid droplet discharged from the discharging hole can be enhanced, and the liquid droplets are easily conveyed and dried, which positively affects production of a particle having a uniform particle size distribution (see FIG. 2B and FIG. 2C).

The shortest distance A (m) from the liquid droplet formation unit to the center of the conveyance gas flow is the shortest distance (horizontal distance) from the discharging hole of the liquid droplet formation unit to a position at which the flow rate of the conveyance gas flow reaches the maximum. The flow rate of the conveyance gas flow generally reaches the maximum at the center of the conveyance path. However, the center of the conveyance gas flow may not be always a position at which the flow rate of the conveyance gas flow reaches the maximum, in the case where the conveyance path is a pipe having a special shape different from general shapes (e.g., circular pipe, triangle pipe, and square pipe) (see, for example, FIG. 2B), or in the case where the path of the conveyance path has a curved structure, or a diameter of a cross section intersecting with the long axis of the conveyance path at a right angle is changed on the way of the path (see, for example, FIG. 2C).

The discharging drive frequency F (Hz) is a drive cycle of a vibration-imparting member configured to impart vibration to the liquid in order to continuously discharge the liquid droplet.

For example, the discharging drive frequency F (Hz) is preferably 1 kHz or more but 2000 kHz or less, more preferably 30 kHz or more but 1000 kHz or less.

Examples of the vibration-imparting member include: (1) “volume-changing member” configured to change volume of the liquid housing section through vibration; (2) “constricted part generation member” configured to discharge a liquid from a plurality of discharging holes provided in the liquid housing section while vibration is applied to the liquid housing section to make a pillar-shaped liquid constricted, followed by formation of liquid droplet; and (3) “nozzle-vibrating member” configured to vibrate a thin film on which discharging holes are formed. Each unit will be described hereinafter.

<<Volume-Changing Member>>

The volume-changing member is not particularly limited and may be appropriately selected depending on the intended purpose, as long as it can change the volume of the liquid housing section and can vibrate the liquid to discharge liquid droplets. Examples of the volume-changing member include piezoelectric elements that are expanded and contracted by application of voltage, and electrothermal conversion elements such as heating resistors.

<<Constricted Part Generation Member>>

Examples of the constricted part generation member include those using the technique described in Japanese Unexamined Patent Application Publication No. 2007-199463. Japanese Unexamined Patent Application Publication No. 2007-199463 describes that a raw material liquid is discharged from a plurality of nozzle holes provided in the liquid housing section while a vibration section using a piezoelectric element, which is in contact with a part of the liquid housing section, applies vibration to the liquid housing section, to make a pillar-shaped raw material liquid constricted, followed by formation of liquid droplets.

<<Nozzle-Vibrating Member>>

Examples of the nozzle-vibrating member include those using the technique described in Japanese Unexamined Patent Application Publication No. 2008-292976. Japanese Unexamined Patent Application Publication No. 2008-292976 describes that a thin film provided in a liquid housing section, in which a plurality of nozzles are formed, and a piezoelectric element configured to vibrate the thin film provided around a region that can be deformed by the film are used to discharge a raw material liquid from the plurality of nozzle holes for formation of liquid droplets.

In order to generate vibration, a piezoelectric element is generally used. The piezoelectric element is not particularly limited, and a shape, a size, and a material thereof can be selected depending on the intended purpose. For example, a piezoelectric element used in conventional inkjet discharging systems can be suitably used.

The shape and the size of the piezoelectric element are not particularly limited and may be appropriately selected depending on, for example, a shape of the discharging hole. The material of the piezoelectric element is not particularly limited and may be appropriately selected depending on the intended purpose. Examples of the material include piezoelectric ceramics (e.g., lead zirconate titanate (PZT)), piezoelectric polymers (e.g., polyvinylidene fluoride (PVDF)), and single crystals (e.g., quartz, LiNbO₃, LiTaO₃, and KNbO₃).

—Discharging Hole—

The discharging hole is not particularly limited and may be appropriately selected depending on the intended purpose. Examples of the discharging hole include an aperture provided in, for example, a nozzle plate.

The number, a cross-sectional shape, and a size of the discharging holes can be appropriately selected.

The number of discharging holes is not particularly limited and may be appropriately selected depending on the intended purpose. For example, the number thereof is preferably 2 or more but 3,000 or less. When the number of discharging holes is 2 or more but 3,000 or less, productivity can be improved.

A cross-sectional shape of the discharging hole is not particularly limited and may be appropriately selected depending on the intended purpose. Examples of the cross-sectional shape include: (1) such a tapered shape that an opening diameter is decreased from a liquid contact surface (inlet) of a discharging hole toward a discharging hole (outlet); (2) such a shape that an opening diameter is narrowed while its round shape is maintained from a liquid contact surface (inlet) of a discharging hole toward a discharging hole (outlet); (3) such a shape that an opening diameter is narrowed from a liquid contact surface (inlet) of a discharging hole toward a discharging hole (outlet) while a certain nozzle angle is maintained; and (4) combinations of the shape of (1) and the shape of (2). Among them, (3) such a shape that an opening diameter is narrowed from a liquid contact surface (inlet) of a discharging hole toward a discharging hole (outlet) while a certain nozzle angle is maintained is preferable because pressure to be applied to a liquid at the discharging hole reaches the maximum.

The nozzle angle in the shape of (3) is not particularly limited and may be appropriately selected depending on the intended purpose. The nozzle angle thereof is preferably 600 or more but 90° or less. When the nozzle angle is 60° or more, pressure is easily applied to a liquid, and processing is easily performed. When the nozzle angle is 90° or less, pressure can be applied at the discharging hole to stabilize discharging of liquid droplets. Therefore, the maximum value of the nozzle angle is preferably 90°.

A size of the discharging hole can be appropriately selected considering the sustained-releasability of a particle to be produced. For example, a diameter of the discharging hole is preferably 12 μm or more but 100 μm or less, more preferably 15 μm or more but 30 μm or less. When the size of the discharging hole is 12 m or more but 100 μm or less, it is possible to obtain a particle having such a sufficient particle diameter that achieves sustained-releasability.

<<Liquid Housing Section>>

The liquid housing section is not particularly limited, and a shape and a size thereof can be appropriately selected depending on the intended purpose, as long as it includes space where a stored liquid containing a physiologically active substance and a polymer is temporarily housed.

—Liquid—

The liquid contains a physiologically active substance and a polymer, and further contains a dispersant, a solvent, and other components, if necessary.

—Physiologically active substance—

The physiologically active substance is not particularly limited and may be appropriately selected depending on the intended purpose. The same as the physiologically active substance contained in the particle of the present disclosure, which will be described hereinafter, can be suitably used.

—Polymer—

The polymer is not particularly limited and may be appropriately selected depending on the intended purpose. The same as the polymer contained in the particle of the present disclosure, which will be described hereinafter, can be suitably used.

—Dispersant—

The dispersant can be suitably used for dispersing the physiologically active substance. When the physiologically active substance is uniformly dispersed in the liquid, the physiologically active substance can be included as a solid in the particle.

The dispersant may be a low-molecular-weight dispersant or a high-molecular-weight dispersant polymer.

The low-molecular-weight dispersant means a compound having a weight average molecular weight of less than 15,000. The high-molecular-weight dispersant polymer means a compound that includes a repeating covalent bond between one or more monomers and has a weight average molecular weight of 15,000 or more.

The low-molecular-weight dispersant is not particularly limited and may be appropriately selected depending on the intended purpose, as long as it is acceptable as a physiologically active substance of a pharmaceutical or the like. Examples of the low-molecular-weight dispersant include lipids, saccharides, cyclodextrins, amino acids, and organic acids. These may be used alone or in combination.

The lipids are not particularly limited and may be appropriately selected depending on the intended purpose. Examples of the lipids include medium chain or long chain monoglyceride, diglyceride, or triglyceride, phospholipids, vegetable oils (e.g., soybean oil, avocado oil, squalene oil, sesame oil, olive oil, corn oil, rapeseed oil, safflower oil, and sunflower oil), fish oils, seasoning oils, water-insoluble vitamins, fatty acids, mixtures thereof, and derivatives thereof. These may be used alone or in combination.

The saccharides are not particularly limited and may be appropriately selected depending on the intended purpose. Examples of the saccharides include glucose, mannose, idose, galactose, fucose, ribose, xylose, lactose, sucrose, maltose, trehalose, turanose, raffinose, maltotriose, acarbose, glycerin, sorbitol, lactitol, maltitol, mannitol, xylitol, erythritol, polyol, and derivatives thereof. These may be used alone or in combination.

The cyclodextrins are not particularly limited and may be appropriately selected depending on the intended purpose. Examples of the cyclodextrins include hydroxypropyl-β-cyclodextrin, β-cyclodextrin, γ-cyclodextrin, α-cyclodextrin, and cyclodextrin derivatives. These may be used alone or in combination.

The amino acids are not particularly limited and may be appropriately selected depending on the intended purpose. Examples of the amino acids include valine, lysine, leucine, threonine, isoleucine, asparagine, glutamine, phenylalanine, aspartic acid, serine, glutamic acid, methionine, arginine, glycine, alanine, thyrosin, proline, histidine, cysteine, tryptophan, and derivatives thereof. These may be used alone or in combination.

The organic acids are not particularly limited and may be appropriately selected depending on the intended purpose. Examples of the organic acids include adipic acid, ascorbic acid, citric acid, fumaric acid, gallic acid, glutaric acid, lactic acid, malic acid, maleic acid, succinic acid, tartaric acid, and derivatives thereof. These may be used alone or in combination.

The high-molecular-weight dispersant polymer is not particularly limited and may be appropriately selected depending on the intended purpose. Examples of the high-molecular-weight dispersant polymer include water-soluble celluloses, polyalkylene glycol, poly(meth)acrylamide, poly(meth)acrylic acid, poly(meth)acrylic acid ester, polyallylamine, polyvinylpyrrolidone, polyvinyl alcohol, polyvinyl acetate, biodegradable polyester, polyglycolic acid, polyamino acid, gelatin, polymalic acid, polydioxanone, and derivatives thereof. These may be used alone or in combination.

The water-soluble celluloses are not particularly limited and may be appropriately selected depending on the intended purpose. Examples of the water-soluble celluloses include alkyl celluloses (e.g., methyl cellulose and ethyl cellulose); hydroxyalkyl celluloses (e.g., hydroxyethylcellulose and hydroxypropylcellulose); and hydroxyalkyl alkyl celluloses (e.g., hydroxyethyl methyl cellulose and hydroxypropyl methylcellulose). These may be used alone or in combination. Among them, hydroxypropylcellulose and hydroxypropyl methylcellulose are preferable, hydroxypropylcellulose is more preferable, in terms of improvement of solubility.

As the hydroxypropylcellulose, various products different in viscosity that is considered to be dependent on the weight average molecular weight, the substitution degree, and the molecular weight are commercially available from various companies, and all of them can be used in the present disclosure.

The weight average molecular weight of the hydroxypropylcellulose is not particularly limited and may be appropriately selected depending on the intended purpose. The weight average molecular weight thereof is preferably 15,000 or more but 400,000 or less. Note that, the weight average molecular weight thereof can be measured through, for example, gel permeation chromatography (GPC).

The viscosity of a 2% by mass aqueous solution (20 degrees Celsius) of the hydroxypropylcellulose is not particularly limited and may be appropriately selected depending on the intended purpose. The viscosity thereof is preferably 2.0 mPa·s (centipoise, cps) or more but 4,000 mPa·s (centipoise, cps) or less.

As the hydroxypropylcellulose, a commercially available product can be used. The commercially available product of hydroxypropylcellulose is not particularly limited and may be appropriately selected depending on the intended purpose. Examples of the commercially available product of hydroxypropylcellulose include: HPC-SSL (molecular weight of 15,000 or more but 30,000 or less and viscosity of 2.0 mPa·s or more but 2.9 mPa·s or less); HPC-SL (molecular weight of 30,000 or more but 50,000 or less and viscosity of 3.0 mPa·s or more but 5.9 mPa·s or less); HPC-L (molecular weight of 55,000 or more but 70,000 or less and viscosity of 6.0 mPa·s or more but 10.0 m Pa·s or less); HPC-M (molecular weight of 110,000 or more but 150,000 or less and viscosity of 150 mPa·s or more but 400 mPa·s or less); and HPC-H (molecular weight of 250,000 or more but 400,000 or less and viscosity of 1,000 mPa·s or more but 4,000 mPa·s or less (all of which are available from Nippon Soda Co., Ltd.). These may be used alone or in combination. Among them, HPC-SSL (molecular weight of 15,000 or more but 30,000 or less and viscosity of 2.0 mPa·s or more but 2.9 mPa·s or less) is preferable.

The polyalkylene glycol is not particularly limited and may be appropriately selected depending on the intended purpose. Examples of the polyalkylene glycol include polyethylene glycol (PEG), polypropylene glycol, polybutylene glycol, and copolymers thereof. These may be used alone or in combination.

The poly(meth)acrylamide is not particularly limited and may be appropriately selected depending on the intended purpose. Examples of the poly(meth)acrylamide include N-methyl (meth)acrylamide, N-ethyl (meth)acrylamide, N-propyl (meth)acrylamide, N-butyl (meth)acrylamide, N-benzil (meth)acrylamide, N-hydroxyethyl (meth)acrylamide, N-phenyl (meth)acrylamide, N-tolyl (meth)acrylamide, N-(hydroxyphenyl)(meth)acrylamide, N-(sulfamoylphenylxmeth)acrylamide, N-(phenylsulfonyl)(meth)acrylamide, N-(tolylsulfonyl)(meth)acrylamide, N,N-dimethyl (meth)acrylamide, N-methyl-N-phenyl (meth)acrylamide, and N-hydroxyethyl-N-methyl (meth)acrylamide. These may be used alone or in combination.

The poly(meth)acrylic acid is not particularly limited and may be appropriately selected depending on the intended purpose. Examples of the poly(meth)acrylic acid include homopolymers (e.g., polyacrylic acid and polymethacrylic acid) and copolymers (e.g., acrylic acid-methacrylic acid copolymer). These may be used alone or in combination.

The poly(meth)acrylic acid ester is not particularly limited and may be appropriately selected depending on the intended purpose. Examples of the poly(meth)acrylic acid ester include ethylene glycol di(meth)acrylate, dethylene glycol di(meth)acrylate, propylene glycol di(meth)acrylate, glycerol poly(meth)acrylate, polyethylene glycol (meth)acrylate, trimethylolpropane tri(meth)acrylate, pentaerythritol tetra(meth)acrylate, and 1,3-butylene glycol di(meth)acrylate.

The polyallylamine is not particularly limited and may be appropriately selected depending on the intended purpose. Examples of the polyallylamine include diallylamine and triallylamine. These may be used alone or in combination.

As the polyvinylpyrrolidone, a commercially available product can be used. The commercially available product of polyvinylpyrrolidone is not particularly limited and may be appropriately selected depending on the intended purpose. Examples of the commercially available product of polyvinylpyrrolidone include PLASDONE C-15 (available from ISP TECHNOLOGIES), Kollidon VA64, Kollidon K-30, and Kollidon CL-M (all of which are available from KAWARLAL), and Kollicoat IR (available from BASF). These may be used alone or in combination.

The polyvinyl alcohol is not particularly limited and may be appropriately selected depending on the intended purpose. Examples of the polyvinyl alcohol include silanol-modified polyvinyl alcohol, carboxyl-modified polyvinyl alcohol, and acetoacetyl-modified polyvinyl alcohol. These may be used alone or in combination.

The polyvinyl acetate is not particularly limited and may be appropriately selected depending on the intended purpose. Examples of the polyvinyl acetate include vinyl acetate-crotonic acid copolymer and vinyl acetate-itaconic acid copolymer. These may be used alone or in combination.

The biodegradable polyester is not particularly limited and may be appropriately selected depending on the intended purpose. Examples of the biodegradable polyester include polylactic acid, poly-ε-caprolactone, succinate-based polymer, and polyhydroxyalkanoate. These may be used alone or in combination.

The succinate-based polymer is not particularly limited and may be appropriately selected depending on the intended purpose. Examples of the succinate-based polymer include polyethylene succinate, polybutylene succinate, and polybutylene succinate adipate. These may be used alone or in combination.

The polyhydroxyalkanoate is not particularly limited and may be appropriately selected depending on the intended purpose. Examples of the polyhydroxyalkanoate include polyhydroxypropionate, polyhydroxybutyrate, and polyhydroxyvalerate. These may be used alone or in combination.

The polyglycolic acid is not particularly limited and may be appropriately selected depending on the intended purpose. Examples of the polyglycolic acid include lactic acid-glycolic acid copolymer, glycolic acid-caprolactone copolymer, and glycolic acid-trimethylene carbonate copolymer. These may be used alone or in combination.

The polyamino acid is not particularly limited and may be appropriately selected depending on the intended purpose. Examples of the polyamino acid include amino acid homopolymers (e.g., poly-α-glutamic acid, poly-γ-glutamic acid, polyaspartic acid, polylysine, polyarginine, polyornithine, and polyserine) and copolymers thereof. These may be used alone or in combination.

The gelatin is not particularly limited and may be appropriately selected depending on the intended purpose. Examples of the gelatin include lime-treated gelatin, acid-treated gelatin, gelatin hydrolysates, gelatin enzyme dispersion products, and derivatives thereof. These may be used alone or in combination.

A natural dispersant polymer used in the gelatin derivatives is not particularly limited and may be appropriately selected depending on the intended purpose. Examples of the natural dispersant include proteins, polysaccharides, and nucleic acids. Copolymers formed of a natural dispersant polymer or a synthesized dispersant polymer are also included. These may be used alone or in combination.

The gelatin derivative means a gelatin derivatized by covalently binding a gelatin molecule with a hydrophobic group. The hydrophobic group is not particularly limited and may be appropriately selected depending on the intended purpose. Examples of the hydrophobic group include polyesters (e.g., polylactic acid, polyglycolic acid, and poly-ε-caprolactone); lipids (e.g., cholesterol and phosphatidylethanolamine); aromatic groups including alkyl groups and benzene groups; aromatic heterocyclic groups, and mixtures thereof.

The protein is not particularly limited and may be appropriately selected depending on the intended purpose. Examples of the protein include collagen, fibrin, and albumin. These may be used alone or in combination.

The polysaccharides are not particularly limited and may be appropriately selected depending on the intended purpose. Examples of the polysaccharides include chitin, chitosan, hyaluronic acid, alginic acid, starch, and pectin. These may be used alone or in combination.

An amount of the dispersant is preferably 5% by mass or more but 95% by mass or less, more preferably 50% by mass or more but 95% by mass or less, relative to a total amount of the particle of the present disclosure. The amount of the dispersant satisfying 5% by mass or more but 95% by mass or less is advantageous because, for example, the dosage as a pharmaceutical composition becomes appropriate, and redispersion of a pharmaceutical ingredient in water by action of the dispersant is easy.

—Solvent—

The solvent is not particularly limited and may be appropriately selected depending on the purpose. Those that can dissolve and disperse a poorly water-soluble compound or a pharmaceutically acceptable salt thereof are preferable.

Examples of the solvent include aliphatic halogenated hydrocarbons (e.g., dichloromethane, dichloroethane, and chloroform), alcohols (e.g., methanol, ethanol, and propanol), ketones (e.g., acetone and methyl ethyl ketone), ethers (e.g., diethyl ether, dibutyl ether, and 1,4-dioxane), aliphatic hydrocarbons (e.g., n-hexane, cyclohexane, and n-heptane), aromatic hydrocarbons (e.g., benzene, toluene, and xylene), organic acids (e.g., acetic acid and propionic acid), esters (e.g., ethyl acetate), and amides (e.g., dimethylformamide and dimethylacetamide). These may be used alone or in combination. Among them, aliphatic halogenated hydrocarbons, alcohols, ketones, and mixed solvents thereof are preferable, dichloromethane, 1,4-dioxane, methanol, ethanol, acetone, and mixed solvents thereof are more preferable, in terms of solubility.

An amount of the solvent is preferably 70% by mass or more but 99.5% by mass or less, more preferably 90% by mass or more but 99% by mass or less, relative to a total amount of the liquid in the present disclosure. The amount of the solvent satisfying 70% by mass or more but 99.5% by mass or less is advantageous in terms of solubility of materials, viscosity of a solution, and production stability.

—Other Ingredients—

The other ingredients are not particularly limited and may be appropriately selected depending on the intended purpose. They are preferably those that can conventionally be used in pharmaceutical compositions.

Examples of the other ingredients include water, an excipient, a flavoring agent, a disintegrating agent, a fluidizer, an adsorbent, a lubricant, an odor-masking agent, a surfactant, a perfume, a colorant, an anti-oxidant, a masking agent, an anti-static agent, and a humectant. These may be used alone or in combination.

The excipient is not particularly limited and may be appropriately selected depending on the intended purpose. Examples of the excipient include lactose, sucrose, mannitol, glucose, fructose, maltose, erythritol, maltitol, xylitol, palatinose, trehalose, sorbitol, crystalline cellulose, talc, silicic anhydride, anhydrous calcium phosphate, precipitated calcium carbonate, and calcium silicate. These may be used alone or in combination.

The flavoring agent is not particularly limited and may be appropriately selected depending on the intended purpose. Examples of the flavoring agent include L-menthol, sucrose, D-sorbitol, xylitol, citric acid, ascorbic acid, tartaric acid, malic acid, aspartame, acesulfame potassium, thaumatin, saccharin sodium, dipotassium glycyrrhizate, sodium glutamate, sodium 5′-inosinateum, and sodium 5′-guanylate. These may be used alone or in combination.

The disintegrating agent is not particularly limited and may be appropriately selected depending on the intended purpose. Examples of the disintegrating agent include low-substituted hydroxypropylcellulose, carmellose, carmellose calcium, carboxymethyl starch sodium, croscarmellose sodium, crospovidone, hydroxypropyl starch, and corn starch. These may be used alone or in combination.

The fluidizer is not particularly limited and may be appropriately selected depending on the intended purpose. Examples of the fluidizer include light anhydrous silicic acid, hydrated silicon dioxide, and talc. These may be used alone or in combination.

As the light anhydrous silicic acid, a commercially available product can be used. The commercially available product of light anhydrous silicic acid is not particularly limited and may be appropriately selected depending on the intended purpose. Examples of the commercially available product of light anhydrous silicic acid include Adsolider 101 (available from Freund Corporation: average pore diameter: 21 nm).

As the adsorbent, a commercially available product can be used. The commercially product of the adsorbent is not particularly limited and may be appropriately selected depending on the intended purpose. Examples of the commercially product of the adsorbent include product name: CARPLEX (ingredient name: synthetic silica, registered trademark of Evonik Japan), product name: AEROSIL (registered trademark of NIPPON AEROSIL CO., LTD.) 200 (ingredient name: hydrophilic fumed silica), product name: SYLYSIA (ingredient name: amorphous silicon dioxide, registered trademark of Fuji Silysia chemical Ltd.), and product name: ALCAMAC (ingredient name: synthetic hydrotalcite, registered trademark of Kyowa Chemical Industry Co., Ltd.). These may be used alone or in combination.

The lubricant is not particularly limited and may be appropriately selected depending on the intended purpose. Examples of the lubricant include magnesium stearate, calcium stearate, sucrose fatty acid ester, sodium stearyl fumarate, stearic acid, polyethylene glycol, and talc. These may be used alone or in combination.

The odor-masking agent is not particularly limited and may be appropriately selected depending on the intended purpose. Examples of the odor-masking agent include trehalose, malic acid, maltose, potassium gluconate, anise essential oil, vanilla essential oil, and cardamom essential oil. These may be used alone or in combination.

The surfactant is not particularly limited and may be appropriately selected depending on the intended purpose. Examples of the surfactant include Polysorbates (e.g., Polysorbate 80); polyoxyethylene·polyoxypropylene copolymer; and sodium lauryl sulfate. These may be used alone or in combination.

The perfume is not particularly limited and may be appropriately selected depending on the intended purpose. Examples of the perfume include lemon oil, orange oil, and peppermint oil. These may be used alone or in combination.

The colorant is not particularly limited and may be appropriately selected depending on the intended purpose. Examples of the colorant include titanium oxide, Food Yellow No. 5, Food Blue No. 2, Ferric oxide, and Yellow Ferric Oxide. These may be used alone or in combination.

The anti-oxidant is not particularly limited and may be appropriately selected depending on the intended purpose. Examples of the anti-oxidant include sodium ascorbate, L-cysteine, sodium sulfite, and vitamin E. These may be used alone or in combination.

The masking agent is not particularly limited and may be appropriately selected depending on the intended purpose. Examples of the masking agent include titanium oxide. These may be used alone or in combination.

The anti-static agent is not particularly limited and may be appropriately selected depending on the intended purpose. Examples of the anti-static agent include talc and titanium oxide. These may be used alone or in combination.

The humectant is not particularly limited and may be appropriately selected depending on the intended purpose. Examples of the humectant include Polysorbate 80, sodium lauryl sulfate, sucrose fatty acid ester, macrogol, and hydroxypropylcellulose (HPC). These may be used alone or in combination.

The liquid may not contain a solvent as long as the liquid is in the state that the physiologically active substance is dissolved, the liquid is in the state that the physiologically active substance is dispersed, or the liquid is in the state of liquid under the discharging condition. The liquid may be in the state that particle ingredients are melted.

<Particle Formation Step and Particle Formation Unit>

The particle formation step is a step of solidifying the liquid droplet to form a particle, and is performed by a particle formation unit.

The particle formation unit is not particularly limited and may be appropriately selected depending on the intended purpose, as long as it is configured to solidify the liquid droplet to form a particle. For example, when the liquid contains a solid raw material dissolved or dispersed in a volatilizable solvent, such a unit that utilizes a conveyance gas flow and is configured to discharge a liquid droplet in the conveyance gas flow to dry the liquid droplet is used.

A method for solidifying the liquid droplet using the conveyance gas flow is not particularly limited and may be appropriately selected depending on the intended purpose. Preferable examples of the method include a method where a conveyance direction of the conveyance gas flow is a substantially vertical direction to a direction in which the liquid droplet is to be discharged. The drying method using the conveyance gas flow will be described in detail in the description of drawings that will be described hereinafter.

In order to dry the solvent, it is preferable to adjust, for example, the temperature and the vapor pressure of the conveyance gas flow, and kinds of gasses.

As long as a collected particle maintains a solid state, even when the collected particle is not completely dried, a drying step may be additionally provided in another step after the collecting. In addition, a method for drying the liquid droplet by application of a temperature change or a chemical change may be used.

<Other Steps>

The other steps are not particularly limited and may be appropriately selected depending on the intended purpose. Examples of the other steps include a particle collecting step.

The particle collecting step is a step of collecting a dried particle and can be suitably performed by a particle collecting unit.

The particle collecting unit is not particularly limited and may be appropriately selected depending on the intended purpose. Examples of the article collecting unit include cyclone collection and bag filters.

Because a liquid is discharged using a discharging unit configured to discharge the liquid using vibration to form liquid droplets in the particle production method and the particle production apparatus of the present disclosure, it is possible to easily control a size of the liquid droplet to be discharged, to increase a particle diameter of the particle, and to narrow the particle size distribution. Therefore, the particle production method and the particle production apparatus of the present disclosure can produce a particle having sustained-releasability that can be controlled with high accuracy.

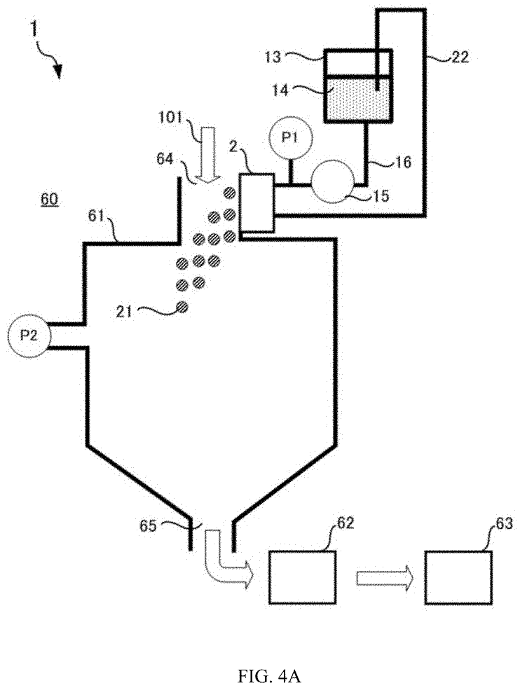

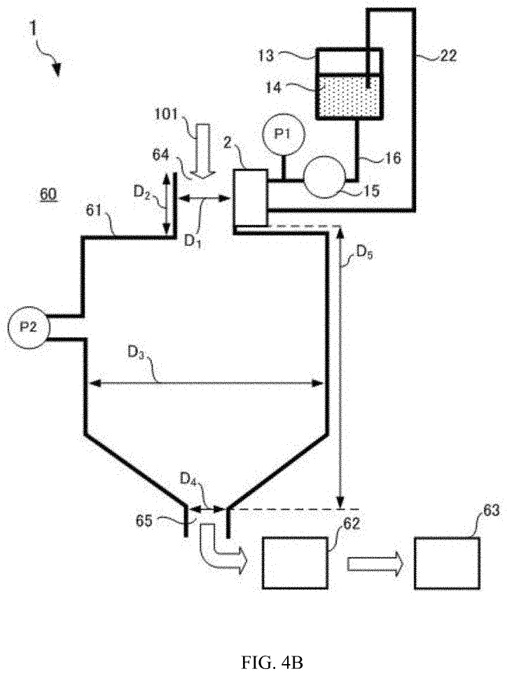

Here, one example of a particle production apparatus used in the particle production method of the present disclosure will be described with reference to FIG. 4A to FIG. 7B.

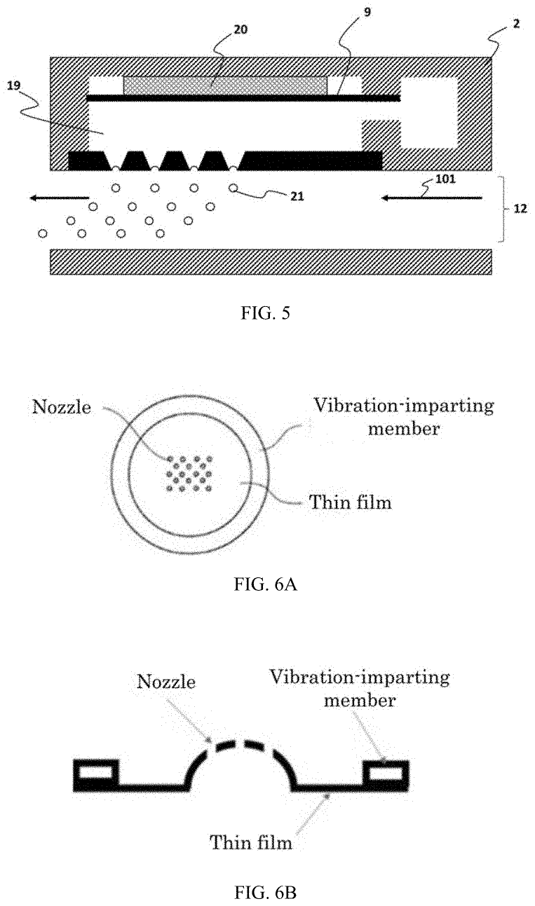

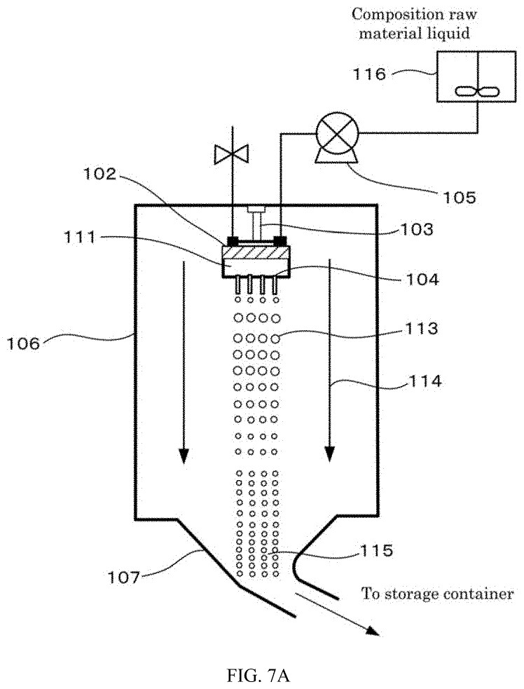

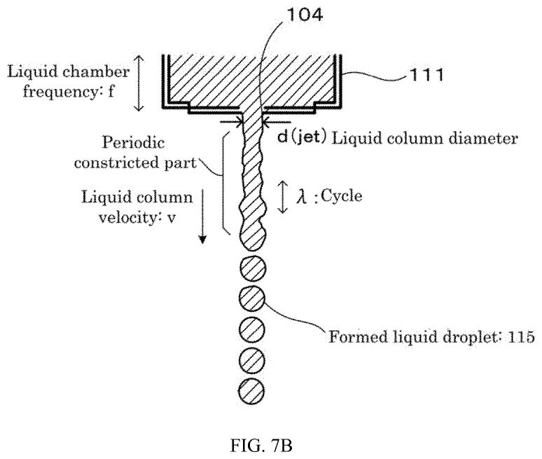

FIG. 4A and FIG. 4B are a schematic view presenting one example of a particle production apparatus. FIG. 5 is a view presenting one example of a liquid droplet formation unit used in the particle production apparatus. FIG. 6A is a view presenting another example of the liquid droplet formation unit used in the particle production apparatus. FIG. 6B is a side view presenting one example of the liquid droplet formation unit presented in FIG. 6A. FIG. 7A is a view presenting another example of the liquid droplet formation unit used in the particle production apparatus. FIG. 7B is a side view presenting one example of the liquid droplet formation unit presented in FIG. 7A.

A particle production apparatus 1 presented in FIG. 4A and FIG. 4B includes a liquid droplet formation unit 2, a drying ⋅ collection unit 60, a conveyance gas flow discharging port 65, and a particle storage section 63. The liquid droplet formation unit 2 is coupled to a liquid housing section 13 configured to house a liquid 14, and a liquid circulating pump 15 configured to supply the liquid 14 housed in the liquid housing section 13 to the liquid droplet formation unit 2 through a liquid supplying pipe 16 and to feed the liquid 14 in the liquid supplying pipe 16 under pressure to return to the liquid housing section 13 through a liquid returning pipe 22. Therefore, the liquid 14 can be supplied to the liquid droplet formation unit 2 at all times. The liquid supplying pipe 16 is provided with a pressure gauge P1 and the drying ⋅ collection unit is provided with a pressure gauge P2. The pressure at which the liquid is fed to the liquid droplet formation unit 2 and the pressure within the drying ⋅ collection unit are controlled by pressure gauges P1 and P2. When a value of pressure measured at P1 is larger than a value of pressure measured at P2, there is a risk that the liquid 14 is oozed from the discharging hole. When a value of pressure measured at P1 is smaller than a value of pressure measured at P2, there is a risk that a gas enters the liquid droplet formation unit 2 to stop discharging. Therefore, it is preferable that a value of pressure measured at P1 and a value of pressure measured at P2 be substantially the same.

Within a chamber 61, a downward gas flow (conveyance gas flow) 101 generated from a conveyance gas flow introducing port 64 is formed. A liquid droplet 21 discharged from the liquid droplet formation unit 2 is conveyed downward not only through gravity but also by through the conveyance gas flow 101, passes through the conveyance gas flow discharging port 65, is collected by a particle collecting unit 62, and is stored in the particle storage section 63.

In the liquid droplet discharging step, when discharged liquid droplets contact with each other before they are dried, the liquid droplets are unified to form a single particle (hereinafter, this phenomenon may be referred to as “cohesion”). In order to obtain a particle having a uniform particle size distribution, it is necessary to maintain a distance between the discharged liquid droplets. Although the liquid droplet travels at a certain initial velocity, the velocity is decreased soon due to air resistance. The liquid droplet decreased in the velocity is caught up with by a liquid droplet subsequently discharged, which leads to cohesion. This phenomenon occurs regularly. Therefore, when a particle formed from this liquid droplet is collected, the particle size distribution considerably becomes worsened. In order to prevent cohesion, it is preferable to dry and convey liquid droplets, while the velocity of the liquid droplet is prevented from being decreased and the liquid droplets do not contact with each other to prevent cohesion by the conveyance gas flow 101, and it is preferable to finally convey the particle to the particle collecting unit 62.

As presented in FIG. 4A, a part of the conveyance gas flow 101 as the first gas flow is provided near the liquid droplet formation unit 2 in the same direction as the direction in which the liquid droplet is discharged. As a result, the velocity of the liquid droplet immediately after the liquid droplet is discharged is prevented from being decreased, which makes it possible to prevent cohesion.

FIG. 5 is a view presenting one example of a liquid droplet formation unit applicable to the particle production apparatuses presented in FIG. 4A and FIG. 4B. As presented in FIG. 5, a liquid droplet formation unit 2 includes a volume-changing member 20, an elastic plate 9, and a liquid housing section 19. When voltage is applied to the volume-changing member 20, the liquid droplet formation unit 2 is deformed to decrease the volume of the liquid housing section 19. As a result, the liquid stored in the liquid housing section 19 is discharged as liquid droplets from a discharging hole.

As described above, after cohesion is prevented by the first gas flow, a dried particle may be conveyed to a particle collecting section by the second gas flow.

The velocity of the first gas flow is preferably equal to or higher than the velocity of the liquid droplet to be discharged. When the velocity of the conveyance gas flow 101 for the purpose of preventing cohesion is lower than the velocity of the liquid droplet to be discharged, it may be difficult to exhibit a function of preventing liquid droplets 21 from contacting with each other, which is a purpose of the conveyance gas flow for preventing cohesion.

As a property of the first gas flow, such a condition that the liquid droplets 21 do not cohere can be added, and the property of the first gas flow may be different from that of the second gas flow. Moreover, such a chemical substance that facilitates drying the surface of the particle may be mixed with or added to the conveyance gas flow for preventing cohesion, in expectation of physical action.

A state of the conveyance gas flow 101 is not particularly limited to a state of the gas flow. The conveyance gas flow 101 may be a laminar flow, a rotational flow, or a turbulent flow. Kinds of gases constituting the conveyance gas flow 101 are not particularly limited and may be appropriately selected depending on the intended purpose. For example, air may be used, or an incombustible gas such as nitrogen may be used. A temperature of the conveyance gas flow 101 can be appropriately adjusted. Preferably, the temperature thereof is not changed at the time of production. A unit configured to change a gas flow condition of the conveyance gas flow 101 may be included within the chamber 61. The conveyance gas flow 101 may be used not only for prevention of cohesion of the liquid droplets 21 but also for prevention of attachment to the chamber 61.

When an amount of the residual solvent contained in the particle obtained by the particle collecting unit 62 presented in FIG. 4A and FIG. 4B is large, the secondary drying is preferably performed if necessary in order to decrease the residual solvent. As the secondary drying, generally known drying units such as fluidized bed drying and vacuum drying can be used. When the solvent remains in the particle, particle characteristics (e.g., heat resistant storage stability, fixability, and charging property) vary over time, and the solvent is volatilized at the time of fixing with heat, which may increase a possibility that users and peripheral devices are adversely affected. Therefore, a sufficient drying is preferably performed.

When an amount of the residual solvent contained in the obtained particle is large, the secondary drying is preferably performed if necessary. As the secondary drying, generally known drying units such as fluidized bed drying and vacuum drying can be used.

When the solvent remains in the produced particle, particle characteristics (e.g., heat resistant storage stability, fixability, and charging property) may vary over time. Therefore, a sufficient drying is preferably performed.

Another example of a particle production apparatus used in the particle production method of the present disclosure is a particle production apparatus described in Japanese Unexamined Patent Application Publication No. 2007-199463. As presented in FIG. 7A and FIG. 7B, the particle production apparatus includes at least a liquid housing section 111 configured to store a particle raw material fluid, a vibration unit 102, and through holes 104. The particle raw material fluid to be released from the through holes 104 is quantitively supplied to the liquid housing section 111, and is quantitively released from the through holes 104, to form the particle raw material fluid into a liquid column. In the production apparatus, the number X of the vibration units and the number Y of the through holes satisfy the following expression:

10*X≤Y≤10000*X.

The vibration unit is in contact with a part constituting the liquid housing section and vibrates the particle raw material fluid via the liquid housing section.

The vibration forms the particle raw material fluid into liquid droplets, which are expected to be dried to solid particles.

For example, as presented in FIG. 7A and FIG. 7B, a preferable particle production apparatus includes, as the liquid droplet formation unit, at least the liquid housing section 111 configured to store the particle raw material fluid, the vibration unit 102, a supporting unit configured to support the vibration unit, and a plurality of the through holes 104, where the particle raw material fluid released from the through holes 104 is quantitively supplied to the liquid housing section 111. Another example is suitably an apparatus including a liquid supplying unit 116 configured to quantitively release the particle raw material fluid from the through holes, a solvent removing section as the particle formation unit 106, and a particle collecting section 107.

(Particle)

A particle of the present disclosure can be suitably produced by the particle production method of the present disclosure.

The particle produced by the particle production method of the present disclosure preferably contains a physiologically active substance and if necessary further contains other ingredients.

—Physiologically Active Substance—

The physiologically active substance is not particularly limited and may be appropriately selected depending on the intended purpose. Examples of the physiologically active substance include pharmaceutical compounds, functional food compounds, and functional cosmetic compounds. When the physiologically active substance in the particle is a solid dispersoid, the physiologically active substance is present in the particle in a state of being uniformly dispersed.

—Pharmaceutical Compound—

The pharmaceutical compound is not particularly limited and may be appropriately selected depending on the intended purpose as long as it can achieve the form of a functional particle or a pharmaceutical composition. Examples of the pharmaceutical compound include poorly-water-soluble compounds and water-soluble compounds.

Specifically, for example, when the poorly-water-soluble compound used as the solid dispersoid is produced as a particle by the below-described particle production method of the present disclosure, its bioavailability can be increased even in, for example, oral administration.

The poorly-water-soluble compound has a log P value of a water/octanol partition coefficient of 3 or greater. The water-soluble compound refers to a compound having a log P value of a water/octanol partition coefficient of less than 3. The water/octanol partition coefficient can be measured by the shake flask method according to JIS Z 7260-107 (2000). The pharmaceutical compound includes any form of compound such as a salt and a hydrate as long as it is effective as a pharmaceutical.

The poorly-water-soluble compound is not particularly limited and may be appropriately selected depending on the intended purpose. Examples of the poorly-water-soluble compound include griseofulvin, itraconazole, norfloxacin, tamoxifen, ciclosporin, glibenclamide, troglitazone, nifedipine, phenacetin, phenytoin, digitoxin, nilvadipine, diazepam, chloramphenicol, indomethacin, nimodipine, dihydroergotoxine, cortisone, dexamethasone, naproxen, tulobuterol, beclometasone propionate, fluticasone propionate, pranlukast, tranilast, loratadine, tacrolimus, amprenavir, bexarotene, calcitriol, clofazimine, digoxin, doxercalciferol, dronabinol, etoposide, isotretinoin, lopinavir, ritonavir, progesterone, saquinavir, sirolimus, tretinoin, valproic acid, amphotericin, fenoldopam, melphalan, paricalcitol, propofol, voriconazole, ziprasidone, docetaxel, haloperidol, lorazepam, teniposide, testosterone, valrubicin, quercetin, and allopurinol. These may be used alone or in combination. Among them, ciclosporin and tranilast are preferable, and ciclosporin is more preferable.

The water-soluble compound is not particularly limited and may be appropriately selected depending on the intended purpose. Examples of the water-soluble compound include abacavir, acetaminophen, aciclovir, amiloride, amitriptyline, antipyrine, atropine, buspirone, caffeine, captopril, chlorquine, chlorpheniramine, cyclophosphamide, desipramine, diazepam, diltiazem, diphenhydramine, disopyramide, doxin, doxycycline, enalapril, ephedrine, ethambutol, ethinylestradiol, fluoxetine, imipramine, clomipramine, glucose, ketorol, ketoprofen, labetalol, levodopa, levofloxacin, metoprolol, metronidazole, midazolam, minocycline, misoprostol, metformin, nifedipine, phenobarbital, prednisolone, promazine, propranolol, quinidine, rosiglitazone, salicylic acid, theophylline, valproic acid, verapamil, zidovudine, and calcitonin. These may be used alone or in combination.

—Functional Food Compound—

The functional food compound is not particularly limited and may be appropriately selected depending on the intended purpose. Examples of the functional food compound include vitamin A, vitamin D, vitamin E, lutein, zeaxanthin, lipoic acid, flavonoid, and fatty acids (e.g., ω-3 fatty acid and ω-6 fatty acid). These may be used alone or in combination.

—Functional Cosmetic Compound—

The functional cosmetic compound is not particularly limited and may be appropriately selected depending on the intended purpose. Examples of the functional cosmetic compound include alcohols, aliphatic alcohols, polyols, aldehydes, alkanolamines, alkoxylated alcohols (e.g., polyethylene glycol derivatives of, for example, alcohols and aliphatic alcohols), amides (e.g., alkoxylated amides, alkoxylated amines, and alkoxylated carboxylic acids), amides (e.g., ceramides) including salts thereof, amines, amino acids including salts and alkyl-substituted derivatives thereof, esters, alkyl-substituted and acyl derivatives, polyacrylic acids, acrylamide copolymers, adipic acid copolymer water, aminosilicones, biological polymers and derivatives thereof, butylene copolymers, carbohydrates (e.g., polysaccharides, chitosan, and derivatives thereof), carboxylic acids, carbomers, esters, ethers, and polymer ethers (e.g., PEG derivatives and PPG derivatives), glyceryl esters and derivatives thereof, halogen compounds, heterocyclic compounds including salts thereof, hydrophilic colloids and derivatives thereof including salts and rubbers thereof (e.g., cellulose derivatives, gelatin, xanthan gum, and natural rubbers), imidazolines, inorganic substances (e.g., clay, TiO₂, and ZnO), ketones (e.g., camphor), isethionates, lanolin, derivatives thereof, organic salts, phenols (e.g., parabens) including salts thereof, phosphorus compounds (e.g., phosphorus derivatives), polyacrylates and acrylate copolymers, proteins and enzyme derivatives (e.g., collagen), synthetic polymers including salts thereof, siloxanes and silanes, sorbitan derivatives, sterols, sulfonic acids and derivatives thereof, and waxes. These may be used alone or in combination.

Particles containing the pharmaceutical compound, the functional food compound, or the functional cosmetic compound can suitably be used as, for example, a pharmaceutical, a food, and a cosmetic.

—Pharmaceutical—

The pharmaceutical contains the pharmaceutical compound and if necessary further contains a dispersant, an additive, and other ingredients.

A dosage form of the pharmaceutical is not particularly limited and may be appropriately selected depending on the intended purpose. Examples of the dosage form include oral preparations, such as tablets (e.g., sugar-coated tablets, film-coated tablets, sublingual tablets, buccal tablets, and orally disintegrating tablets), pills, granules, powder, capsules (e.g., soft capsules and microcapsules), syrup, emulsions, suspensions, and films (e.g., orally disintegrating films and mucoadhesive buccal films). Other examples of the dosage form according to different administration methods include parenteral preparations, such as injections, instillation, transdermal delivery agents (e.g., iontophoresis transdermal delivery agents), suppository, ointment, intranasal administration agents, intrapulmonary administration agents, and eye drops. Moreover, the pharmaceutical composition may be a controlled release preparation, such as a rapid-release preparation or a sustained-release preparation (e.g., sustained-release microcapsules).

—Food—

The food contains a functional food compound and if necessary further contains a dispersant, an additive, and other ingredients.

The food is not particularly limited and may be appropriately selected depending on the intended purpose. Examples of the food include: frozen desserts such as ice cream, ice sherbet and ice shavings; noodles such as buckwheat noodles, wheat noodles, vermicelli, coats of Chinese dumplings, coats of pork dumplings, Chinese noodles, and instant noodles; snacks such as candies, gum, chocolate, tabletted snacks, munches, biscuits, jelly, jam, cream, baked confectionery, and bread; marine products such as crab, salmon, Japanese littleneck, tuna, sardine, shrimps, prawns, bonito, mackerel, whale, oyster, saury, squid, bloody clam, scallop, abalone, sea chestnut, salmon caviar, and Sulculus diversicolor superlexla; marine/livestock processed foods such as fish minced and steamed, ham, and sausage; dairy products such as processed milk and fermented milk; fats and oils or processed foods thereof such as salad oil, Tempura oil, margarine, mayonnaise, shortening, whip cream, and dressing; seasonings such as sauce and basting; retort pouch foods such as curry, stew, Oyako-don (a bowl of rice topped with boiled chicken and eggs), rice porridge, Zosui (rice soup), Chuka-don (a bowl of rice with a chop-suey-like mixture on it), Kalsu-don (a rice bowl with pork cutlets), Ten-don (a tempura rice bowl), Una-don (an eel rice bowl), havashi rice (hashed beef with rice), Oden (a dish containing several ingredients such as boiled eggs and radish), mapo doufu, Gyu-don (a beef rice bowl), meat sauce, egg soup, rice omelet, Chinese dumplings, pork dumplings, hamburger steak, and meat balls; and healthy foods and dietary supplements in various forms.

—Cosmetic—

The cosmetic contains a functional cosmetic compound and if necessary further contains a dispersant, an additive, and other ingredients.

The cosmetic is not particularly limited and may be appropriately selected depending on the intended purpose. Examples of the cosmetic include skincare cosmetics, make-up cosmetics, haircare cosmetics, body-care cosmetics, and fragrance cosmetics.

The skincare cosmetics are not particularly limited and may be appropriately selected depending on the intended purpose. Examples of the skincare cosmetics include cleansing compositions for make-up removal, face washes, milky lotions, lotions, beauty liquids, skin moisturizers, pack agents, and cosmetics for shaving (e.g., shaving foams, pre-shave lotions, and aftershave lotions).

The make-up cosmetics are not particularly limited and may be appropriately selected depending on the intended purpose. Examples of the make-up cosmetics include foundations, lipsticks, and mascaras.

The haircare cosmetics are not particularly limited and may be appropriately selected depending on the intended purpose. Examples of the haircare cosmetics include hair shampoos, hair rinses, hair conditioners, hair treatments, and hair styling preparations (e.g., hair jell, hair set lotions, hair liquids, and hair mists).

The body-care cosmetics are not particularly limited and may be appropriately selected depending on the intended purpose. Examples of the body-care cosmetics include body soaps, sunscreen cosmetics, and massage creams.

The fragrance cosmetics are not particularly limited and may be appropriately selected depending on the intended purpose. Examples of the fragrance cosmetics include colognes (e.g., perfumes and parfums), Eau de parfums (e.g., perfume cologne), Eau de toilettes (e.g., perfumed toilette and parfum de toilette), and Eau de colognes (e.g., cologne and fresh cologne).

An amount of the physiologically active substance contained in the particle is not particularly limited and may be appropriately selected depending on the intended purpose. The amount of the physiologically active substance is preferably 5% by mass or more but 95% by mass or less, more preferably 5% by mass or more but 50% by mass or less.

—Polymer—

The polymer is used in the following manners, for example. The physiologically active substance is allowed to adsorb to the polymer, to control the release rate of the physiologically active substance. The physiologically active substance is covered with a coating film made of the polymer to form into a capsule.

The polymer is not particularly limited and may be appropriately selected depending on the intended purpose as long as it is a polymer that is poorly soluble or insoluble in water and has biocompatibility. Examples of the polymer that is degradable in a biological body include polyfatty acid esters, poly-α-cyanoacrylic acid esters, poly-β-hydroxybutyric acid, polyalkylene oxalate, polyorthoesters, polyorthocarbonates, other polycarbonates, and polyamino acids. These may be used alone or in combination.

Examples of the polyfatty acid esters include polylactic acid, polyglycolic acid, and polymalic acid.

The polyfatty acid ester to be used may be an appropriately synthesized product or a commercially available product.

Examples of the commercially available product of the polyfatty acid ester include PLGA-7510 (a lactic acid/glycolic acid copolymer, available from Wako Pure Chemical Industries, Ltd.).

Examples of the other polymers having biocompatibility include polystyrenes, polyurethanes, polyvinyl acetates, polyvinyl alcohols, polyacrylamides, polyacrylic acids, polymethacrylic acids, copolymers of acrylic acid and methacrylic acid, polyamino acids, silicon polymers, dextran stearate, maleic anhydride-based copolymers, ethyl cellulose, acetyl cellulose, nitrocellulose, nylon, and TETORON. These may be used alone or in combination.

—Other Ingredients—

The other ingredients are not particularly limited and may be appropriately selected depending on the intended purpose. Examples of the other ingredients include the above-listed water, an excipient, a flavoring agent, a disintegrating agent, a fluidizer, an adsorbent, a lubricant, an odor-masking agent, a surfactant, a perfume, a colorant, an anti-oxidant, a masking agent, an anti-static agent, and a humectant. These may be used alone or in combination. Details for these are not referred to because they are similar to those described above.

<Volume Average Particle Diameter (Dv) of Particle>

A volume average particle diameter (Dv) of the particle is preferably 10 μm or more but 100 μm or less, more preferably 15 μm or more but 30 μm or less.

When the volume average particle diameter (Dv) of the particle is 10 μm or more but 100 μm or less, it is possible to obtain a particle retaining the physiologically active substance that is releasable for a long period of time.

When the volume average particle diameter (Dv) of the particle is 10 μm or more, the polymer can properly retain the physiologically active substance to prevent initial burst, and a long-term sustained release effect can be obtained.

When the volume average particle diameter (Dv) of the particle is 100 μm or less, the particle has an appropriate size for administration to a biological body, and an energy can be reduced that is necessary for drying liquid droplets in the production of the particle.

<Number Average Particle Diameter (Dn) of Particle>

A number average particle diameter (Dn) of the particle is preferably 10 μm or more but 100 μm or less, more preferably 12 μm or more but 30 μm or less. When the number average particle diameter (Dn) of the particle is 10 μm or more but 100 μm or less, the surface are of the particle per unit mass can be increased, and the amount of the physiologically active substance eluted per unit time can be increased.

When the number average particle diameter (Dn) of the particle is 10 μm or more, the polymer can be contained in an amount that is enough to adsorb the physiologically active substance, and long-term sustained releasability can be exhibited.

<Particle Size Distribution of Particle (Volume Average Particle Diameter (Dv)/Number Average Particle Diameter (Dn))>

A particle size distribution of the particle is a value obtained by dividing the volume average particle diameter (Dv) by the number average particle diameter (Dn). The particle size distribution of the particle is preferably 1.00 or more but 1.50 or less, more preferably 1.00 or more but 1.20 or less, further preferably 1.00 or more but 1.10 or less.

When the particle size distribution of the particle is 1.00 or more but 1.50 or less, the size of the particle becomes uniform, and the amounts of the physiologically active substance and the polymer contained in each particle become uniform. As a result, it is possible to strictly control the amount of an active ingredient and deliverability to a certain site and sustained releasability.

The volume average particle diameter (Dv), the number average particle diameter (Dn), and the particle size distribution (Dv/Dn) of the particle can be measured using, for example, a laser diffraction/scattering particle size distribution analyzer (device name: MICROTRAC MT3000II, available from MicrotracBEL Corp.).

<Amount of Physiologically Active Substance in Particle>

An amount of the physiologically active substance contained in the particle is preferably 25% by mass or more, more preferably 25% by mass or more but 75% by mass or less, in terms of a mass ratio to the particle after drying.

In the particle production method and apparatus of the present disclosure, the amount of the physiologically active substance contained in the particle can be controlled by adjusting the formulation of a liquid mixture. The particle production method and apparatus of the present disclosure can produce a particle containing the physiologically active substance at a higher ratio than in other production methods. For example, the particle can be allowed to contain the physiologically active substance in an amount of 15% by mass or more or 20% by mass or more, in terms of a mass ratio to the particle after drying. The amount of the physiologically active substance can be controlled depending on the required releasability. In particular, when the amount of the physiologically active substance contained in the particle is 25% by mass or more, the particle can elute the physiologically active substance for a long period of time and in a stable manner.

Also, when the amount of the physiologically active substance contained in the particle is 25% by mass or more but 75% by mass or less, releasability can be accurately controlled while increasing the amount of the physiologically active substance contained in the particle.

The particle of the present disclosure contains a physiologically active substance and a polymer. The amount of the physiologically active substance is 25% by mass or more relative to the mass of the particle after drying. When the volume average particle diameter (Dv) of the particle is 10 μm or more but 100 μm or less and the particle size distribution of the particle (the volume average particle diameter (Dv)/the number average particle diameter (Dn)) is 1.00 or more but 1.50 or less, it is possible to control releasability highly accurately and allow the particle to contain a high concentration of the physiologically active substance.

### EXAMPLES

Examples of the present disclosure will be described hereinafter. However, the present disclosure should not be construed as being limited to these Examples.

### Example 1

—Production of Particle by Volume-Changing Member (Piezo System)—

<Preparation of Liquid Mixture A>

Clomipramine hydrochloride (obtained from Wako Pure Chemical Industries, Ltd.) (8 parts by mass) was dissolved in methanol (obtained from Wako Pure Chemical Industries, Ltd.) (40 parts by mass). The obtained solution (48 parts by mass), lactic acid-glycolic acid copolymer (product name: PLGA-5010, obtained from Wako Pure Chemical Industries, Ltd.) (12 parts by mass), and acetone (obtained from Wako Pure Chemical Industries, Ltd.) (40 parts by mass) were mixed under stirring using a stirring device (device name: magnetic stirrer, obtained from AS ONE Corporation.) for 1 hour at 1,000 rpm, followed by passing the resultant through a 1 μm-filtration filter (product name: Millex SLFA05010, obtained from Merck) to prepare liquid mixture A.

<Formation of Particle 1>

Using a liquid droplet discharging apparatus 1 (device name: GEN4, obtained from Ricoh Company, Ltd.) that included a liquid droplet formation unit 2 (the same as “2” in FIG. 4B) including a volume-changing member presented in FIG. 5, the prepared liquid mixture A was used to form a liquid droplet under the following particle formation conditions, followed by drying the formed liquid droplet to form particle 1. Note that, as the discharging system of the liquid droplet discharging apparatus, the inkjet discharging using a piezoelectric element was used. In FIG. 4B, the lengths of the respective portions (D1 to D5) were D1: 0.02 m, D2: 0.1 m, D3: 0.5 m, D4: 0.2 m, and D5: 1.0 m, respectively.

—Particle Formation Conditions—

—Liquid Droplet Formation Unit—

Shape of discharging hole: perfect circle

Diameter of discharging hole: 24 μm

Number of opened discharging hole: 384

Discharging drive frequency (F): 32 kHz

—Liquid—

Density (ρ) of the liquid: 1050 kg/m³

—Liquid Droplet to be Discharged—

Diameter (d0) of the liquid droplet to be discharged: 30 μm

Angle (θ) at which the liquid droplet is to be discharged: 65°

Velocity (Vj) of the liquid droplet to be discharged: 15 m/s

—Particle Formation Unit—

Conveyance gas flow: Air

Temperature of conveyance gas flow: 50 degrees Celsius

Velocity (Vx) of conveyance gas flow: 18 m/s

Height (D₅) of conveyance path: 1 m

Distance (A) from liquid droplet formation unit to center of conveyance gas flow: 0.01 m

Note that, the “diameter (d0) of the liquid droplet to be discharged” and the “velocity (Vj) of the liquid droplet to be discharged” were measured using a liquid droplet observation device (device name: EV1000, obtained from Ricoh Company, Ltd.) with a LED backlight. The “angle (θ) at which the liquid droplet is to be discharged” was adjusted to 65°, where the angle (θ) is an angle at which a traveling direction of the liquid droplet at the moment when the liquid droplet is discharged from the discharging hole (nozzle) intersects with a direction of stress the liquid droplet receives from the conveyance gas flow (see, for example, FIG. 3A and FIG. 3B).

The “density (ρ) of the liquid” was measured using a specific gravity bottle (device name: pycnometer (Wadon), obtained from SIBATA SCIENTIFIC TECHNOLOGY LTD.).

Based on the above particle formation conditions, the following Formula 1 was used to calculate the value of P. Results are presented in Table 1.

$$\begin{matrix}[ Math . 6 ] & \\ P = \frac{Vj}{Fd 0} \sqrt{\frac{ρ Vx}{2 A}} {cos}^{2} ( θ - 65 ) > 1 & Formula 1\end{matrix}$$

### Example 2

—Production of Particle by Nozzle-Vibrating Member—

<Formation of Particle 2>

Particle 2 was formed in the same manner as in Example 1 except that the liquid droplet formation unit 2 was changed to a liquid droplet formation unit including a nozzle-vibrating member presented in FIGS. 6A and 6B, and the particle formation conditions in Example 1 were changed to the following particle formation conditions.

A thin film in the nozzle-vibrating member presented in FIGS. 6A and 6B was obtained by forming discharging holes having a perfect circle shape and a diameter of 25 μm on a nickel plate having an outer diameter of 8 mm and a thickness of 20 μm through electroforming.

The discharging holes were provided in the form of a hound's tooth check only within the range of 5 mm in diameter (φ) from the center of the thin film so that each distance between centers of discharging holes would be 100 μm. Note that, an angle, at which a traveling direction of the liquid droplet at the moment when the liquid droplet is discharged from the discharging hole (nozzle) positioned in the center of the nozzle-vibrating member intersects with a direction of the conveyance gas flow, was measured as the angle θ at which the liquid droplet is to be discharged from the nozzle-vibrating member.

—Particle Formation Conditions—

—Liquid Droplet Formation Unit—

Shape of discharging hole: perfect circle

Diameter of discharging hole: 25 μm

Number of opened discharging hole: 64

Discharging drive frequency (F): 108 kHz

—Liquid—

Density (ρ) of the liquid: 1050 kg/m³

—Liquid Droplet to be Discharged—

Diameter (d0) of the liquid droplet to be discharged: 30 μm

Angle (θ) at which the liquid droplet is to be discharged: 650

Velocity (Vj) of the liquid droplet to be discharged: 7 m/s

—Particle Formation Unit—

Conveyance gas flow: Air

Temperature of conveyance gas flow: 50 degrees Celsius

Velocity (Vx) of conveyance gas flow: 18 m/s

Height (D₅) of conveyance path: 1 m

Distance (A) from liquid droplet formation unit to center of conveyance gas flow: 0.01 m

### Example 3

—Production of Particle by Nozzle-Vibrating Member—

<Formation of Particle 3>

Particle 3 was formed in the same manner as in Example 2 except that the diameter of the discharging hole was changed to 30 μm and the height (D₅) of the conveyance path was changed to 2 m.

### Example 4

—Formation of Particle by Constricted Part Generation Member—

<Formation of Particle 4>

Particle 4 was formed in the same manner as in Example 1 except that the liquid droplet formation unit 2 was changed to a liquid droplet formation unit including a constricted part generation member presented in FIG. 7B, and the particle formation conditions in Example 1 were changed to the following particle formation conditions.

Regarding the part in the constricted part generation member where through holes exist as presented in FIG. 7B, 10 through holes having a perfect circle shape and an outlet diameter of 30 μm were concentrically produced on a nickel plate having a thickness of 20 μm through removal machining (laser ablation) by the mask reduction projection method using femtosecond laser. The part where through holes were present failed within the range of a square of side 0.5 mm.

—Particle Formation Conditions—

—Liquid Droplet Formation Unit—

Shape of discharging hole: perfect circle

Diameter of discharging hole: 50 μm

Number of opened discharging hole: 10

Discharging drive frequency (F): 150 kHz

—Liquid—

Density (ρ) of the liquid: 1050 kg/m³

—Liquid Droplet to be Discharged—

Diameter (d0) of the liquid droplet to be discharged: 60 μm

Angle (θ) at which the liquid droplet is to be discharged: 650

Velocity (Vj) of the liquid droplet to be discharged: 30 m/s

—Particle Formation Unit—

Conveyance gas flow: Air

Temperature of conveyance gas flow: 50 degrees Celsius

Velocity (Vx) of conveyance gas flow: 18 m/s

Height (D₅) of conveyance path: 5 m

Distance (A) from liquid droplet formation unit to center of conveyance gas flow: 0.01 m

### Example 5

—Production of Particle by Constricted Part Generation Member—

<Formation of Particle 5>

Particle 5 was formed in the same manner as in Example 4 except that the diameter of the discharging hole was changed to 25 μm, the discharging drive frequency was changed to 600 kHz, and the height (D₅) of the conveyance path was changed to 2 m.

### Comparative Example 1

—Formation of Particle by Nozzle-Vibrating Member—

<Formation of Particle 6>

Particle 6 was formed in the same manner as in Example 2 except that the liquid droplet discharging apparatus was changed to the liquid droplet discharging apparatus (D1: 1.0 m, D2: absence, D3: 1.0 m, D4: 1.0 m, and D5: 1.0 m) presented in FIG. 4B. However, before formation of a particle, discharged liquid droplets coalesced with each other to form a large liquid droplet, a particle could not formed in the conveyance path, and the liquid droplet fell to the bottom of the apparatus as it was. Therefore, a particle could not be formed.

### Comparative Example 2

—Production of Particle by Nozzle-Vibrating Member—

<Formation of Particle 7>

Particle 7 was formed in the same manner as in Example 2 except that the angle at which the liquid droplet is to be discharged was changed from 65° to 10°.

### Comparative Example 3

—Production of Particle by Nozzle-Vibrating Member—

<Formation of Particle 8>

Particle 8 was formed in the same manner as in Example 2 except that the velocity of the conveyance gas flow was changed to 2 m/s.

### Comparative Example 4

—Production of Particle by Constricted Part Generation Member—

<Formation of Particle 9>

Particle 9 was formed in the same manner as in Example 5 except that the velocity of the liquid droplet to be discharged was changed to 10 m/s, the velocity of the conveyance gas flow was changed to 2 m/s, the height (D₅) of the conveyance path was changed to 1 m, and the discharging drive frequency (F) was changed to 108 kHz.

### Comparative Example 5

—Production of Particle by Constricted Part Generation Member—

<Formation of Particle 10>

Particle 10 was formed in the same manner as in Example 5 except that the angle at which the liquid droplet is to be discharged was changed to 120°, the velocity of the conveyance gas flow was changed to 2 m/s, the height (D₅) of the conveyance path was changed to 1 m, and the discharging drive frequency (F) was changed to 108 kHz.

TABLE 1

| | | | | | | | | Distance A | | |
|---|---|---|---|---|---|---|---|---|---|---|
| | | | | | Diameter | | Velocity of | between | | |
| | | | Discharging | Discharging | of liquid | Liquid | conveyance | nozzle and | | |
| | | | velocity | frequency | droplet | density | gas flow | center of | Discharging | |
| | | Discharging | Vj | F | d 0 | ρ | Vx | gas flow | angle θ | Value |
| | | unit: | (m/s) | (kHz) | (μm) | (kg/m³) | (m/s) | (m) | (deg) | of P |
| Examples | 1 | Volume-changing | 15 | 32 | 30 | 1050 | 18 | 0.01 | 65 | 21.5 |
| | | unit | | | | | | | | |
| | 2 | Nozzle vibration | 7 | 108 | 30 | 1050 | 18 | 0.01 | 65 | 3 |
| | | unit | | | | | | | | |
| | 3 | Nozzle vibration | 7 | 108 | 36 | 1050 | 18 | 0.01 | 65 | 2.5 |
| | | unit | | | | | | | | |
| | 4 | Constricted part | 30 | 150 | 60 | 1050 | 18 | 0.01 | 65 | 4.6 |
| | | generation unit | | | | | | | | |
| | 5 | Constricted part | 30 | 600 | 30 | 1050 | 18 | 0.01 | 65 | 2.3 |
| | | generation unit | | | | | | | | |
| Comparative | 1 | Nozzle vibration | 7 | 108 | 30 | 1050 | 18 | 0.5 | 65 | 0.4 |
| Examples | | unit | | | | | | | | |
| | 2 | Nozzle vibration | 7 | 108 | 30 | 1050 | 18 | 0.01 | 10 | 1 |
| | | unit | | | | | | | | |
| | 3 | Nozzle vibration | 7 | 108 | 30 | 1050 | 2 | 0.01 | 65 | 1 |
| | | unit | | | | | | | | |
| | 4 | Constricted part | 10 | 600 | 30 | 1050 | 18 | 0.01 | 65 | 0.8 |
| | | generation unit | | | | | | | | |
| | 5 | Constricted part | 30 | 600 | 30 | 1050 | 18 | 0.01 | 120 | 0.8 |
| | | generation unit | | | | | | | | |

Then, the particles 1 to 10 obtained in Examples 1 to 5 and Comparative Examples 1 to 5 were measure and evaluated for “particle size distribution [volume average particle diameter (Dv)/number average particle diameter (Dn)]” in the following manner. Results are presented in Table 2.

<Particle Size Distribution [Volume Average Particle Diameter (Dv)/Number Average Particle Diameter (Dn)]>

The particle size distribution was measured using a laser diffraction/scattering particle size distribution analyzer (device name: MICROTRAC MT3000II, obtained from MicrotracBEL Corp.). Note that, measurement and analysis conditions were set as follows.

—Measurement and Analysis Conditions of Particle Size Distribution—

Measurement mode: transparent mode

Particle refractive index: 1.40

Set Zero time: 10 seconds

Measurement time: 10 seconds

The particle size distribution was evaluated based on the following evaluation criteria.

<Evaluation Criteria>

1.0≤(Dv)/(Dn)≤1.5 A:

1.0>(Dv)/(Dn), or (Dv)/(Dn)>1.5 B:

TABLE 2

| | | | Volume | Number | | |
|---|---|---|---|---|---|---|
| | | | average | average | Evaluation | |
| | | | particle | particle | Criteria | |
| | | | diameter | diameter | Particle size | |
| | | Collection | (Dv) | (Dn) | distribution | |
| | | of particle | (μm) | (μm) | (Dv/Dn) | Evaluation |
| Examples | 1 | Collected | 17.4 | 16.7 | 1.04 | A |
| | 2 | Collected | 18.2 | 16.8 | 1.24 | A |
| | 3 | Collected | 22 | 19.2 | 1.25 | A |
| | 4 | Collected | 35.3 | 28.4 | 1.08 | A |
| | 5 | Collected | 17.8 | 14.2 | 1.15 | A |
| Compar- | 1 | Not | — | — | — | B |
| ative | | Collected | | | | |
| Examples | 2 | Collected | 50 | 15.8 | 3.16 | B |
| | 3 | Collected | 46.7 | 16.2 | 2.88 | B |
| | 4 | Collected | 48.4 | 14.5 | 3.34 | B |
| | 5 | Collected | 60.2 | 14.8 | 4.07 | B |

Aspects of the present disclosure are as follows, for example.

<1> A particle production apparatus including:

a liquid droplet formation unit configured to discharge a liquid from a discharging hole to form a liquid droplet; and
a particle formation unit configured to solidify the liquid droplet to form a particle,
wherein the particle formation unit includes a conveyance gas flow, and
the liquid droplet formation unit is configured to discharge the liquid so as to satisfy Formula 1 below:

$$\begin{matrix}[ Math . 7 ] & \\ P = \frac{Vj}{Fd 0} \sqrt{\frac{ρ Vx}{2 A}} {cos}^{2} ( θ - 65 ) > 1 & Formula 1\end{matrix}$$

where in the Formula 1, Vj represents a velocity (m/s) of the liquid droplet to be discharged, F represents a discharging drive frequency (kHz), d0 represents a diameter (μm) of the liquid droplet, ρ represents a density (kg/m³) of the liquid, Vx represents a velocity (m/s) of the conveyance gas flow, A represents shortest distance (m) from the liquid droplet formation unit to a center of the conveyance gas flow, and θ represents an angle (deg.) at which the liquid droplet is to be discharged.

<2> The particle production apparatus according to <1>,

wherein the value of P is 2 or more.

<3> The particle production apparatus according to <1> or <2>,

wherein the angle at which the liquid droplet is to be discharged is 40° or more but 90° or less.

<4> The particle production apparatus according to any one of <1> to <3>,

wherein the liquid droplet formation unit is configured to vibrate the liquid to discharge the liquid droplet.

<5> The particle production apparatus according to any one of <1> to <4>,

wherein the liquid droplet formation unit includes a piezoelectric element.

<6> The particle production apparatus according to any one of <1> to <5>,

wherein the liquid droplet formation unit is provided in a thin film including the discharging hole.

<7> The particle production apparatus according to any one of <1> to <6>,

wherein an average particle diameter of the particle formed is from 10 μm through 100 μm.

<8> A particle production method including:

discharging a liquid from a discharging hole to form a liquid droplet by a liquid droplet formation unit; and
solidifying the liquid droplet to form a particle by a particle formation unit,
wherein the particle formation unit includes a conveyance gas flow, and the liquid droplet formation unit is configured to discharge the liquid so as to satisfy Formula 1 below:

$$\begin{matrix}[ Math . 8 ] & \\ P = \frac{Vj}{Fd 0} \sqrt{\frac{ρ Vx}{2 A}} {cos}^{2} ( θ - 65 ) > 1 & Formula 1\end{matrix}$$

where in the Formula 1, Vj represents a velocity (m/s) of the liquid droplet to be discharged, F represents a discharging drive frequency (kHz), d0 represents a diameter (μm) of the liquid droplet, ρ represents a density (kg/m³) of the liquid, Vx represents a velocity (m/s) of the conveyance gas flow, A represents shortest distance (m) from the liquid droplet formation unit to a center of the conveyance gas flow, and θ represents an angle (deg.) at which the liquid droplet is to be discharged.

The particle production apparatus according any one of <1> to <7> and the particle production method according to <8> can solve the conventionally existing problems and to achieve the object of the present disclosure.

### REFERENCE SIGNS LIST

1: particle production apparatus
2: liquid droplet formation unit
13: liquid housing section
14: liquid
20: volume-changing member
21, 113: liquid droplet
101, 114: conveyance gas flow

1: A particle production apparatus, comprising:
a liquid droplet formation unit configured to discharge a liquid from a discharging hole to form a liquid droplet; and
a particle formation unit configured to solidify the liquid droplet to form a particle,
wherein the particle formation unit includes a conveyance gas flow, and the liquid droplet formation unit is configured to discharge the liquid so as to satisfy Formula 1 below:
$$P = \frac{Vj}{Fd 0} \sqrt{\frac{ρ Vx}{2 A}} {cos}^{2} ( θ - 65 ) > 1 \qquad Formula 1$$
where in the Formula 1, Vj represents a velocity (m/s) of the liquid droplet to be discharged, F represents a discharging drive frequency (kHz), d0 represents a diameter (μm) of the liquid droplet, ρ represents a density (kg/m³) of the liquid, Vx represents a velocity (m/s) of the conveyance gas flow, A represents shortest distance (m) from the liquid droplet formation unit to a center of the conveyance gas flow, and θ represents an angle (deg.) at which the liquid droplet is to be discharged.

2: The particle production apparatus according to claim 1, wherein the value of P is 2 or more.

3: The particle production apparatus according to claim 1, wherein the angle at which the liquid droplet is to be discharged is 400 or more but 90° or less.

4. The particle production apparatus according to claim 1, wherein the liquid droplet formation unit is configured to vibrate the liquid to discharge the liquid droplet.

5: The particle production apparatus according to claim 1, wherein the liquid droplet formation unit includes a piezoelectric element.

6: The particle production apparatus according to claim 1, wherein the liquid droplet formation unit is provided in a thin film including the discharging hole.

7: The particle production apparatus according to claim 1, wherein a volume average particle diameter of the particle formed is from 10 μm through 100 μm.

8: A particle production method, comprising:
discharging a liquid from a discharging hole to form a liquid droplet by a liquid droplet formation unit; and
solidifying the liquid droplet to form a particle by a particle formation unit,
wherein the particle formation unit includes a conveyance gas flow, and the liquid droplet formation unit is configured to discharge the liquid so as to satisfy Formula 1 below:
$$P = \frac{Vj}{Fd 0} \sqrt{\frac{ρ Vx}{2 A}} {cos}^{2} ( θ - 65 ) > 1 \qquad Formula 1$$
where in the Formula 1, Vj represents a velocity (m/s) of the liquid droplet to be discharged, F represents a discharging drive frequency (kHz), d0 represents a diameter (μm) of the liquid droplet, ρ represents a density (kg/m³) of the liquid. Vx represents a velocity (m/s) of the conveyance gas flow, A represents shortest distance (m) from the liquid droplet formation unit to a center of the conveyance gas flow, and θ represents an angle (deg.) at which the liquid droplet is to be discharged.

9: The particle production apparatus according to claim 1, wherein the velocity (m/s) of the liquid droplet to be discharged is 5 m/s or more but 50 m/s or less.

10: The particle production apparatus according to claim 1, wherein the discharging drive frequency (kHz) is 1 kHz or more but 2000 kHz or less.

11: The particle production apparatus according to claim 1, wherein the diameter (μm) of the liquid droplet is 5 μm or more but 100 μm or less.

12: The particle production apparatus according to claim 1, wherein the density (kg/m³) of the liquid is 500 kg/m³ or more but 1500 kg/m³ or less.

13: The particle production apparatus according to claim 1, wherein the velocity (m/s) of the conveyance gas flow is 4 m/s or more but 50 m/s or less.
